(19) United States
(12) Patent Application Publication
(10) Pub. No.: US 2004/0086218 A1
(43) Pub. Date: May 6, 2004

(54) Apparatus and method for optical signal processing system

(75) Inventors: Chun-Kai Liu, Hsinchu (TW); Chengkuo Lee, Hsinchu (TW)

Correspondence Address: BRUCE H. TROXELL, SUITE 1404, 5205 LEESBURG PIKE, FALLS CHURCH, VA, 22041, US

(73) Assignee: ASIA PACIFIC MICROSYSTEMS, INC.

(21) Appl. No.: 10/284,266

(22) Filed: Oct. 31, 2002

(51) Int. Cl. G02B 6/26; G02B 6/28

(52) U.S. Cl. 385/18; 385/137; 385/24

(57) ABSTRACT

The present invention generally relates to optical communication systems, and more particularly, to an apparatus combining microelectromechanical systems (MEMS) elements and optical wavelength division multiplexing/demultiplexing (WDM) elements for optical wavelength selective add/drop application. Wherein, optical fiber arrays or optical planar waveguide arrays are used as the input terminal and the output terminal of multiple optical signals. Moreover, 1×N one-dimensional micro-mirror arrays manufactured by using the MEMS technology are applied to change the transmitting directions of the optical signal of each channel between the input terminals and the output terminals, thus, it achieves the purpose of switching the optical signals from one channel of input terminals to another corresponding channel of output terminals. If the above-mentioned optical fiber arrays or optical planar waveguide arrays are replaced or combined with arrayed waveguide gratings (AWG) as multiplexers and demultiplexers, this apparatus can be applied as a wavelength selective optical add/drop multiplexer (OADM), or a reconfigurable optical add/drop multiplexer (ROADM), and is capable of achieving the high-channel-counts demands of all-optical network in the future.

### BACKGROUND OF THE INVENTION

1. Field of the Invention

The present invention generally relates to optical communication systems, and more particularly, to an apparatus combining microelectromechanical systems (MEMS) elements and optical wavelength division multiplexing/demultiplexing (WDM) elements for optical wavelength selective add/drop application. Wherein, optical fiber arrays or optical planar waveguide arrays are used as the input terminal and the output terminal of multiple optical signals. Moreover, 1×N one-dimensional micro-mirror arrays manufactured by using the MEMS technology are applied to change the transmitting directions of the optical signal of each channel between the input terminals and the output terminals, thus, it achieves the purpose of switching the optical signals from one channel of input terminals to another corresponding channel of output terminals. Moreover, in an optical network, there is a need to add (originate) and drop (terminate) optical signals of traffic in ends of links or nodes of intersecting point of several connected ring-like networks. Let the first pair of input and output terminals be used as the device for handling the on-going traffic signals, and the second pair of input and output terminals as the adding ports of new signals into present traffic and the dropping ports of signals to be terminated in current traffic. Thus, the optical signals of different channels can be individually transmitted to output terminal or can be independently dropped, while new signals can be individually added into corresponding channels of output terminal of first pair via the adding ports of second pair of terminals. Therefore the optical signals can be added in or dropped from traffic independently for each channels.

If the above-mentioned optical fiber arrays or the optical planar waveguide arrays are replaced by arrayed waveguide grating (AWG), then the 1×N one-dimensional micro-mirror arrays are able to switch optical signals of specific wavelength from one input channel of demultiplexer of AWG to one corresponding output channel of multiplexer of AWG Moreover, if the above-mentioned pair of input and output terminals of AWG is used as the first pair device for handling the ongoing traffic signals, then second pair of input and output terminals of AWG can act as the adding ports of new signals into present traffic and the dropping ports of signals to be terminated in current traffic. Thus, the optical signals with the selected wavelength can be added or dropped independently. This apparatus is commonly referred to as a wavelength selective optical add/drop multiplexer (OADM), or a reconfigurable optical add/drop multiplexer (ROADM).

Wherein the particular optical signals of selected wavelengths can be individually added-into and dropped-from a set of optical signals of plural wavelengths in one channel of optical networks using dense wavelength division multiplexing (DWDM) optical network system.

2. Description of the Prior Art

In the optical communication network system, wherein, at the location of the nodes, the transmitting path of the optical signals with various wavelengths always needs to be switched from one channel to another, or optical signals with selected wavelengths are needed to be replaced, terminated, or originated corresponding to particular channels.

Some methods for manufacturing the optical signal processing systems, which are able to handle multi-wavelength optical signals and add-drop functions, had been disclosed. These patents are now described as follows:

(1) As the U.S. Pattern No. 6,097,859 has disclosed a multi-wavelength WDM cross-connect optical switch device developed by Olav Solgaard etc. (please refer to FIG. 1-1 and the reference material 1). In this device, signals from the wavelength channels of input fibers 12a, 12b, 12c, i.e., the input terminals, are collimated and spatially dispersed by a first diffraction grating-lens system 11. This grating-lens system 11 (please refer to FIG. 1-2) acts as a demlutiplexer (DEMUX) separates the optical signals of different wavelengths from the input terminals in a direction perpendicular to the plane of a paper, and the dispersed wavelength channels are then focused onto a corresponding spatial layer of plane with MEMS mirror switching matrix 13. The transmitting paths of the optical signals of same wavelength in a spatial layer of plane can be adjusted in terms of light direction being re-directed by controlling deflection angle of MEMS mirrors. In the other words, the MEMS mirrors 16a, 16b, 16c, and 17a, 17b, 17c are able to switch the optical signals from one input port to one output port in the ways shown in FIGS. 1-3 and 1-4. Then various wavelengths signals from different spatial layers of plane are collimated, recombined, and converged by a second diffraction grating-lens system 14 onto the three optical fibers 15a, 15b, 15c of the output terminal. In this process, the second diffraction grating-lens system 14 acts as the multiplexer (MUX). Additionally, the surface of the above-mentioned MEMS mirrors is parallel to the silicon substrate, for example, while manufacturing the multi-wavelength cross-connect optical switch with F optical fiber input terminals and W channels, the micro-mirror array then consists of two WXF mirror array planes 16, 17. The structure of the optical system is complicated, so it is difficult to be manufactured.

(2) The U.S. Pat. No. 6,148,124 has disclosed an apparatus for multi-wavelength optical signal add-drop multiplexing device developed by Vladimir A. Aksyuk etc. (please refer to FIG. 2-1 and the reference material 2). An arrayed waveguide grating (AWG) 21 is used as a wavelength demultiplexing device, while a MEMS optical shutter 22 (please refer to FIG. 2-2), which is driven by electrical static force, acts as an on-off switch for controlling the transmission or reflection of optical signals with said wavelengths. Additionally a circulator 23 is applied to complete the process of dropping-out, i.e., terminating, optical signals with said wavelengths. The other optical signals that passed through the shutter are converged, i.e., multiplexed, into one single channel of the output terminal by another AWG 24. For new optical signals can be added-into the output terminal via coupler or switch component 25. By doing so, this disclosed configuration can act as a OADM device. Therefore, it is impossible to directly prevent the action of adding-in new optical signals with exisiting said wavelengths in the output terminal.

(3) The U.S. Pat. No. 5,745,612 has disclosed a wavelength sorting multiplexer developed by Wey-Kuo Wang etc. (please refer to FIG. 3 and the reference material 3). An arrayed waveguide grating (AWG) with an N×N array is used as both demultiplexer (DEMUX) and multiplexer (MUX). The optical signals with W wavelengths of the waveguides 32 with the amount of F at the input terminal are separated by means of various wavelengths. The transmitting paths of these optical signals with said wavelengths can be changed by the F×F optical switch array 33 with the amount of W, and can be inputted into the above-mentioned AWG again. Thereafter signals are converged and multiplexed again via the F waveguides 34. As a result, it can be applied to the multi-wavelength OADM application. Wherein, the value of N is greater than the product of F and (w+1), thus the amount of the channels and the capacity of the wavelengths are limited while applying this apparatus. Therefore, it is complicated and difficult to be manufactured with higher cost, and it has a greater amount of components.

(4) The U.S. Pat. Nos. 5,953,141 and 6,208,443 B1 has disclosed an apparatus for multi-wavelength OADM device developed by Karen Liu etc. (please refer to FIG. 4 and the reference materials 4, 5). It consists of a tunable reflection filters 41 and circulator 42. Without using the MEMS based approach, this disclosed apparatus is bulky typically.

### SUMMARY OF THE INVENTION

The present invention is to provide an apparatus and method for optical signal processing system that can be used as wavelength selective optical add/drop multiplexer (OADM), or a reconfigurable optical add/drop multiplexer (ROADM). It applies the micromachining, MEMS technology, and wafer level packaging technology to produce this apparatus in so-called batch type process and environment. So the cost is low and the reliability and the stability are enhanced.

According to the apparatus of the present invention, optical fiber arrays or optical planar waveguide arrays are used as the input and output terminals for the multi-wavelength optical signals. The single or plural 1×N one-dimensional MEMS mirror arrays are used for changing and controlling the transmitting directions of the optical signals with said channels between the input and output terminals, and thus enabled the said multi-wavelength optical signals of a channel to be switched to another corresponding channels. V-shaped or U-shaped groove arrays on the substrate or carrier substrate made by well-known micromachining technology is applied to help the fiber array alignment and assembly work in a very precise manner.

Supposing the optical fiber array or the optical planar waveguide array of the above-mentioned input and output terminals is replaced by a 1×N or an N×1 arrayed waveguide grating (AWG), multi-wavelength optical signals from a single input channel can be separated or demultiplexed into each different individual channels with said wavelengths. Then single or plural 1×N one-dimensional micro-mirror arrays are able to switch the optical signal(s) of specific wavelength(s) from the output channel(s) of demultiplexer of AWG to the corresponding input channel(s) of multiplexer of AWG So the optical signals with various wavelengths are multiplexed to form a multi-wavelength optical signal in single output channel. Moreover, if the above-mentioned pair of input and output terminals of AWG is used as the first pair device for handling the on-going traffic signals, then second pair of input and output terminals of AWG can act as the adding ports of new signals into present traffic and the dropping ports of signals to be terminated in current traffic. Thus, the optical signals with the selected wavelength can be added or dropped independently. This apparatus is commonly referred to as a wavelength selective optical add/drop multiplexer (OADM), or a reconfigurable optical add/drop multiplexer (ROADM).

In aforementioned invention, the said wavelength division multiplexer/demultiplexer (WDMUX/DEMUX) can be made of the optical fiber grating or thin film filter technology.

In addition, we may add WDMUX/DEMUX elements made of AWQ optical fiber grating, or thin film filter in the front-end and back-end of the said input and output terminals made of optical fiber array or optical planar waveguide array to form a device that is above-mentioned wavelength selective optical add/drop multiplexer (OADM), or reconfigurable optical add/drop multiplexer (ROADM) device of present invention.

On the other hand, fixed reflective mirrors manufactured by the micromachining, microfabrication, or electroplating technology, or optical fiber and optical planar waveguide with 45° facet end can be applied for re-direct optical signals with fixed angles. Such elements can be integrated with said MEMS mirror to fulfill the requirement present invented apparatus, while the number of MEMS mirror will be reduced in this case.

Additionally current invention includes the ways of enhancing the optical transmission efficiency or optical coupling efficiency based on adding various types of optical device at the interface of guided wave and free-space wave of any in/out points. These optical devices are like collimating lens, collecting lens i.e. ball lens, cylindrical lens, refractive micro-lens (referring to reference materials 6, 7), diffractive micro-lens i.e. Fresnel lens (referring to reference materials 8, 9), and others non-spherical lens etc.

The apparatus of the present invention can be divided into two layers according to its physical configuration. All the function elements can be fabricated onto two discrete substrates, and then these two separate substrates are fixed and bonded together by means of packaging and bonding process. Meanwhile, other active and passive optical and electrical components can be selectively integrated and assembled onto the said substrates during the packaging process. Thereafter the completed apparatus of present invention is produced. Since the manufacturing process of present invention is a batch type wafer level process, the key feature of present invention is hybrid-assembly of discrete functional elements onto a carrier substrate with the other integrated functional elements, based on the known wafer level packaging technologies, i.e. wafer to wafer bonding, flip-chip bonding, die attach/bonding, etc. After the first-level package of the device of present invention done in wafer form stage, the device dicing process is being proceeded, thereafter the alignment and sealing process of the input/output optical interconnections, i.e., fibers or waveguides, is executed. Then the final product housing can be conducted when we already knew the devices intended to be packaging are function or malfunction. In this manner, we are able to make the devices in a lower cost way.

The accompanying drawings, which are included to provide a further understanding of the invention and are incorporated in and constitute a part of this specification, illustrate embodiments of the referred disclosed prior art and information of present invention.

### BRIEF DESCRIPTION OF THE DRAWINGS

FIG. 1-1 shows a multi-wavelength cross-connect optical switch developed by Olav Solgaard et al.

FIG. 1-2 is a cross-sectional view showing a grating used in the multi-wavelength cross-connect optical switch developed by Olav Solgaard et al.

FIG. 1-3 is a perspective view showing a micro-mirror array used in the multi-wavelength cross-connect optical switch developed by Olav Solgaard et al.

FIG. 1-4 is a 3-dimensional perspective view showing a micro-mirror array used in the multi-wavelength cross-connect optical switch developed by Olav Solgaard et al.

FIG. 2-1 shows a multi-wavelength division multiplexed optical signal add-drop multiplexer developed by Vladimir A. Aksyuk et al.

FIG. 2-2 is a perspective showing a micro-electro-mechanical shutter used in the multi-wave length division multiplexed optical signal add-drop multiplexer developed by Vladimir A. Aksyuk et al.

FIG. 3 shows a wavelength sorting multiplexer developed by Weyl-kuo Wang et al.

FIG. 4 shows a dynamic optical add-drop multiplexer developed by Karen Liu et al.

FIG. 5 is a 3-dimensional perspective view showing the states that the optical signals inside the optical fibers are exchanged correspondingly between the four one-dimensional arrays of optical fibers according to the present invention.

FIG. 6-1 is a 3-dimensional perspective view showing the multi-wavelength optical signal add-drop multiplexing apparatus I according to the present invention.

FIG. 6-2 is a perspective view showing the non-dropped-out state of the k^{th} channel optical signal inside the multi-wavelength optical signal add-drop multiplexing apparatus I according to the present invention.

FIG. 6-3 is a perspective view showing the non-dropped-out state of the k+1^{th} channel optical signal inside the of the multi-wavelength optical signal add-drop multiplexing apparatus I according to the present invention.

FIG. 6-4 is a perspective view showing the dropped-out state of the k−1^{th} channel optical signal inside the of the multi-wavelength optical signal add-drop multiplexing apparatus I according to the present invention.

FIG. 6-5 is a perspective view showing the state of the new optical signal added-into the k−1^{th} channel inside the multi-wavelength optical signal add-drop multiplexing apparatus I according to the present invention.

FIG. 6-6 is a perspective view showing the state of dropping-out the old signal and adding-in the new signal at the same time of the k−1^{th} channel inside the multi-wavelength optical signal add-drop multiplexing apparatus I according to the present invention.

FIG. 7-1 is a perspective view showing the non-dropped-out state of the k^{th} channel optical signal inside the multi-wavelength optical signal add-drop multiplexing apparatus II according to the present invention.

FIG. 7-2 is a perspective view showing the non-dropped-out state of the k+1^{th} channel optical signal inside the of the multi-wavelength optical signal add-drop multiplexing apparatus II according to the present invention.

FIG. 7-3 is a perspective view showing the dropped-out state of the k−1^{th} channel optical signal inside the of the multi-wavelength optical signal add-drop multiplexing apparatus II according to the present invention.

FIG. 7-4 is a perspective view showing the state of the new optical signal added-into the k−1^{th} channel inside the multi-wavelength optical signal add-drop multiplexing apparatus II according to the present invention.

FIG. 7-5 is a perspective view showing the state of dropping-out the old signal and adding-in the new signal at the same time of the k−1^{th} channel inside the multi-wavelength optical signal add-drop multiplexing apparatus 11 according to the present invention.

FIG. 8-1 is a perspective view showing the non-dropped-out state of the k^{th} channel optical signal inside the multi-wavelength optical signal add-drop multiplexing apparatus III according to the present invention.

FIG. 8-2 is a perspective view showing the non-dropped-out state of the k+1^{th} channel optical signal inside the of the multi-wavelength optical signal add-drop multiplexing apparatus III according to the present invention.

FIG. 8-3 is a perspective view showing the dropped-out state of the k−1^{th} channel optical signal inside the of the multi-wavelength optical signal add-drop multiplexing apparatus III according to the present invention.

FIG. 8-4 is a perspective view showing the state of the new optical signal added-into the k−1^{th} channel inside the multi-wavelength optical signal add-drop multiplexing apparatus III according to the present invention.

FIG. 8-5 is a perspective view showing the state of dropping-out the old signal and adding-in the new signal at the same time of the k−1^{th} channel inside the multi-wavelength optical signal add-drop multiplexing apparatus III according to the present invention.

FIG. 9-1 is a perspective view showing the non-dropped-out state of the k^{th} channel optical signal inside the multi-wavelength optical signal add-drop multiplexing apparatus IV according to the present invention.

FIG. 9-2 is a perspective view showing the non-dropped-out state of the k+1^{th} channel optical signal inside the of the multi-wavelength optical signal add-drop multiplexing apparatus IV according to the present invention.

FIG. 9-3 is a perspective view showing the dropped-out state of the k−1^{th} channel optical signal inside the of the multi-wavelength optical signal add-drop multiplexing apparatus IV according to the present invention.

FIG. 9-4 is a perspective view showing the state of the new optical signal added-into the k−1^{th} channel inside the multi-wavelength optical signal add-drop multiplexing apparatus IV according to the present invention.

FIG. 9-5 is a perspective view showing the state of dropping-out the old signal and adding-in the new signal at the same time of the k−1^{th} channel inside the multi-wavelength optical signal add-drop multiplexing apparatus IV according to the present invention.

FIG. 10-1 is a perspective view showing the non-dropped-out state of the k^{th} channel optical signal inside the multi-wavelength optical signal add-drop multiplexing apparatus V according to the present invention.

FIG. 10-2 is a perspective view showing the non-dropped-out state of the k+1^{th} channel optical signal inside the of the multi-wavelength optical signal add-drop multiplexing apparatus V according to the present invention.

FIG. 10-3 is a perspective view showing the dropped-out state of the k−1^{th} channel optical signal inside the of the multi-wavelength optical signal add-drop multiplexing apparatus V according to the present invention.

FIG. 10-4 is a perspective view showing the state of the new optical signal added-into the k−1^{th} channel inside the multi-wavelength optical signal add-drop multiplexing apparatus V according to the present invention.

FIG. 10-5 is a perspective view showing the state of dropping-out the old signal and adding-in the new signal at the same time of the k−1^{th} channel inside the multi-wavelength optical signal add-drop multiplexing apparatus V according to the present invention.

FIG. 11-1 is a perspective view showing the non-dropped-out state of the k^{th} channel optical signal inside the multi-wavelength optical signal add-drop multiplexing apparatus VI according to the present invention.

FIG. 11-2 is a perspective view showing the non-dropped-out state of the k+1^{th} channel optical signal inside the of the multi-wavelength optical signal add-drop multiplexing apparatus VI according to the present invention.

FIG. 11-3 is a perspective view showing the dropped-out state of the k−1^{th} channel optical signal inside the of the multi-wavelength optical signal add-drop multiplexing apparatus VI according to the present invention.

FIG. 11-4 is a perspective view showing the state of the new optical signal added-into the k−1^{th} channel inside the multi-wavelength optical signal add-drop multiplexing apparatus VI according to the present invention.

FIG. 11-5 is a perspective view showing the state of dropping-out the old signal and adding-in the new signal at the same time of the k−1^{th} channel inside the multi-wavelength optical signal add-drop multiplexing apparatus VI according to the present invention.

FIG. 12-1 is a 3-dimensional perspective view showing the multi-wavelength optical signal add-drop multiplexing apparatus VII according to the present invention.

FIG. 12-2 is a perspective view showing the non-dropped-out state of the k^{th} channel optical signal inside the multi-wavelength optical signal add-drop multiplexing apparatus VII according to the present invention according to the present invention.

FIG. 12-3 is a perspective view showing the state of dropping-out the old signal and adding-in the new signal at the same time of the k−1^{th} channel inside the multi-wavelength optical signal add-drop multiplexing apparatus VII according to the present invention.

FIG. 13-1 is a perspective view showing the non-dropped-out state of the k^{th} channel optical signal inside the multi-wavelength optical signal add-drop multiplexing apparatus VIII according to the present invention according to the present invention.

FIG. 13-2 is a perspective view showing the state of dropping-out the old signal and adding-in the new signal at the same time of the k−1^{th} channel inside the multi-wavelength optical signal add-drop multiplexing apparatus VIII according to the present invention.

FIG. 14-1 is a 3-dimensional perspective view showing the multi-wavelength optical signal add-drop multiplexing apparatus IX according to the present invention.

FIG. 14-2 is a perspective view showing the non-dropped-out state of the k^{th} channel optical signal inside the multi-wavelength optical signal add-drop multiplexing apparatus IX according to the present invention according to the present invention.

FIG. 14-3 is a perspective view showing the state of dropping-out the old signal and adding-in the new signal at the same time of the k−1^{th} channel inside the multi-wavelength optical signal add-drop multiplexing apparatus IX according to the present invention.

FIG. 15-1 is a perspective view showing the non-dropped-out state of the k^{th} channel optical signal inside the multi-wavelength optical signal add-drop multiplexing apparatus X according to the present invention according to the present invention.

FIG. 15-2 is a perspective view showing the state of dropping-out the old signal and adding-in the new signal at the same time of the k−1^{th} channel inside the multi-wavelength optical signal add-drop multiplexing apparatus X according to the present invention.

FIG. 16 is a perspective view showing the four-wavelength optical signal add-drop multiplexing apparatus according to the present invention.

FIG. 17 is a perspective view showing another structure of the multi-wavelength optical signal add-drop multiplexing apparatus according to the present invention.

FIG. 18 is a perspective view of an embodiment showing the apparatus for optical signal processing system is assembled to two substrates.

FIG. 19 is a perspective view of an embodiment showing the apparatus for optical signal processing system is in the wafer level manufacturing process.

### DETAILED DESCRIPTION OF THE PREFERRED EMBODIMENT

Embodiments of the apparatus and method for optical signal processing system according to the present invention will now be explained in detail with reference to the accompanying drawings.

### EXAMPLE 1

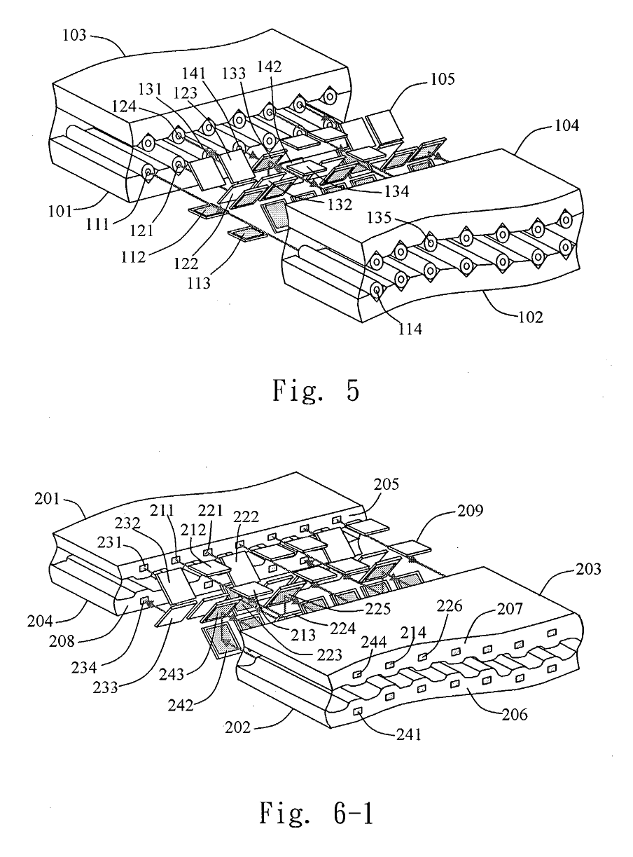

As shown in FIG. 5, a 3-dimensional perspective view of the present invention showing the exchanging state of optical signals inside the optical fibers correspondingly between the four one-dimension arrays of optical fibers is illustrated. V-shaped or U-shaped groove arrays on the substrate or carrier substrate made by well-known micromachining technology is applied to help the fiber array alignment and assembly work in a very precise manner. By using the micro-electro-mechanical technology, a three-dimensional array 105 of stand-able micro-mirrors is formed to change the propagation paths of the optical signals between the optical fiber arrays. Thus, the optical signal of each corresponding channel inside the one-dimensional optical fiber arrays can be exchanged. The above-mentioned three-dimensional array 105 of stand-able micro-mirrors consists of four 1×N one-dimensional arrays of micro-mirrors. Said micro-mirrors can be driven by known actuation schemes including thermal, election-static, electromagnetic, piezoelectric, air pressure difference, and hydraulic pressure difference. The structure of above-mentioned stand-able micro-mirror can also be manufactured by using the MUMPs (Multi User MEMS Processes) provided by Cronos Integrated Microsystems.

The optical signal, outputted from the k-1^{th} optical fiber 111 of the 1^{st} one-dimension optical fiber array 101, and passing through the two micro-mirrors 112 and 113, is inputted into the k−1^{th} optical fiber 114 of the 2^{nd} one-dimension optical fiber array 102, and transmitted continuously. Wherein, the surfaces of the micro-mirror 112 and 113 are parallel to the propagation direction of the optical signal, so that the propagation path of the optical signal is unchanged. The optical signal, outputted from the k^{th} optical fiber 121 of the 1^{st} one-dimension optical fiber array 101, and reflected by the two micro-mirror 122 and 123, is inputted into the K^{th} optical fiber 124 of the 3^{rd} one-dimension optical fiber array device 103 and transmitted continuously. The optical signal, outputted from the k+1^{th} optical fiber 131 of the 1^{st} one-dimension optical fiber array 101, reflected by the two micro-mirror 132 and 133, and then passing through the micro-mirror 134, is inputted into the k+1^{th} optical fiber 135 of the 4^{th} one-dimension optical fiber array 104 and transmitted continuously. Wherein, the surface of the micro-mirror 134 is parallel to the propagation direction of the optical signal, so that the propagation path of the optical signal is unchanged. The optical signal, outputted from the k+2^{th} optical fiber 141 of the 1^{st} one-dimension optical fiber array 101, and reflected by the micro-mirror 142, is inputted back into the former optical fiber 141 and transmitted continuously. Wherein, the surface of the micro-mirror 142 is perpendicular to the propagation direction of the optical signal, so that the propagation path of optical signal is turned reversely. Following the above-mentioned methods, the propagation paths of the optical signals inside the optical fibers can be rearranged.

The above-mentioned one-dimension optical fiber array can be replaced by the optical planar waveguide array. Furthermore, the outer ends of the one-dimension optical fiber arrays or the optical planar waveguide arrays can be connected with optical signal demultiplexers or multiplexers manufactured by the technology of arrayed waveguide grating, optical fiber grating, or thin film filter, and then the apparatus for optical signal processing system of the present invention is enabled with multi-wavelength optical signal add-drop multiplexing.

### EXAMPLE 2

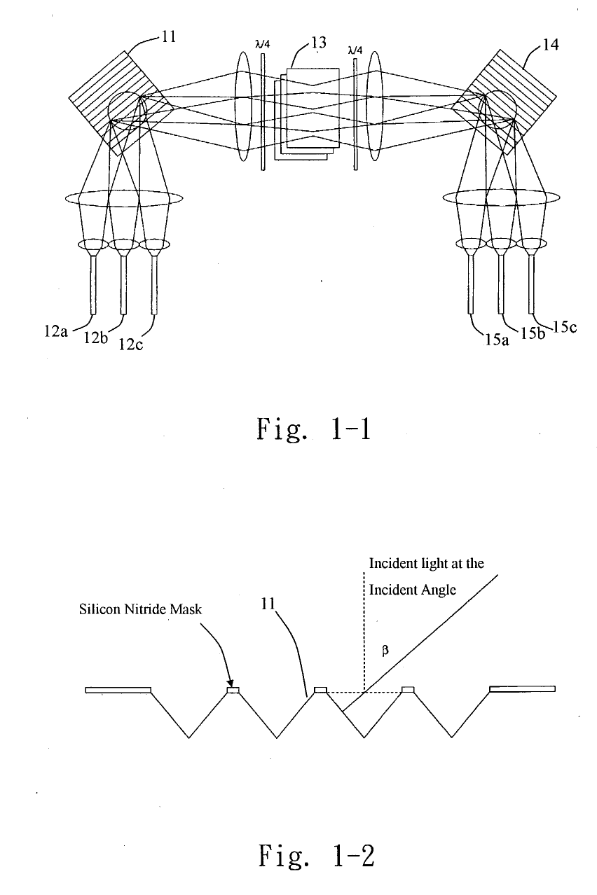

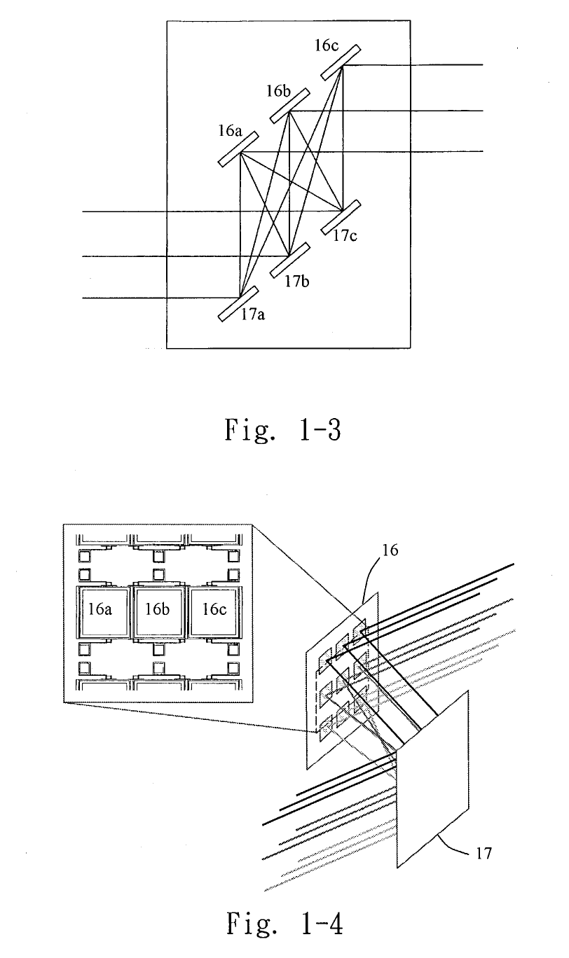

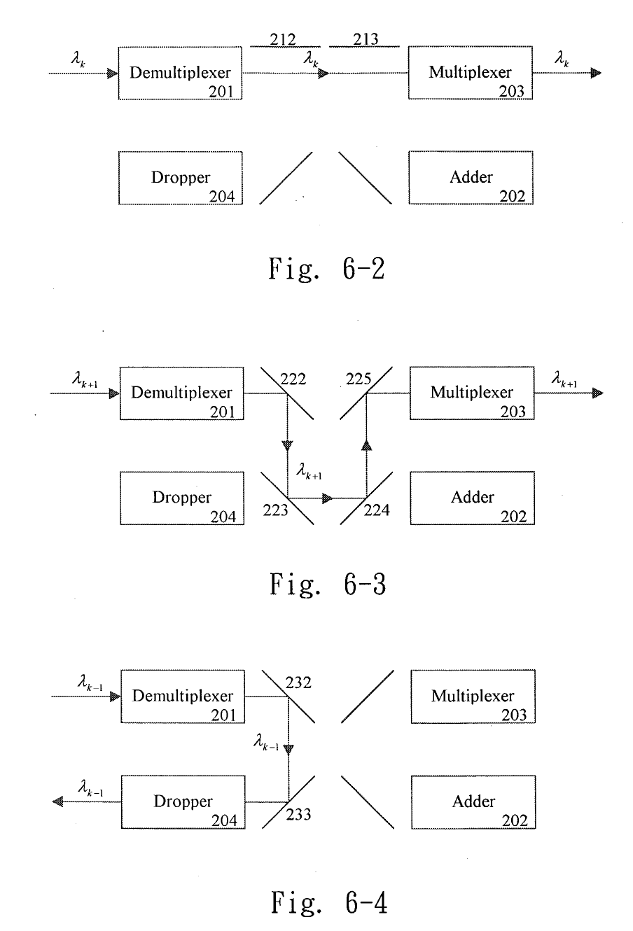

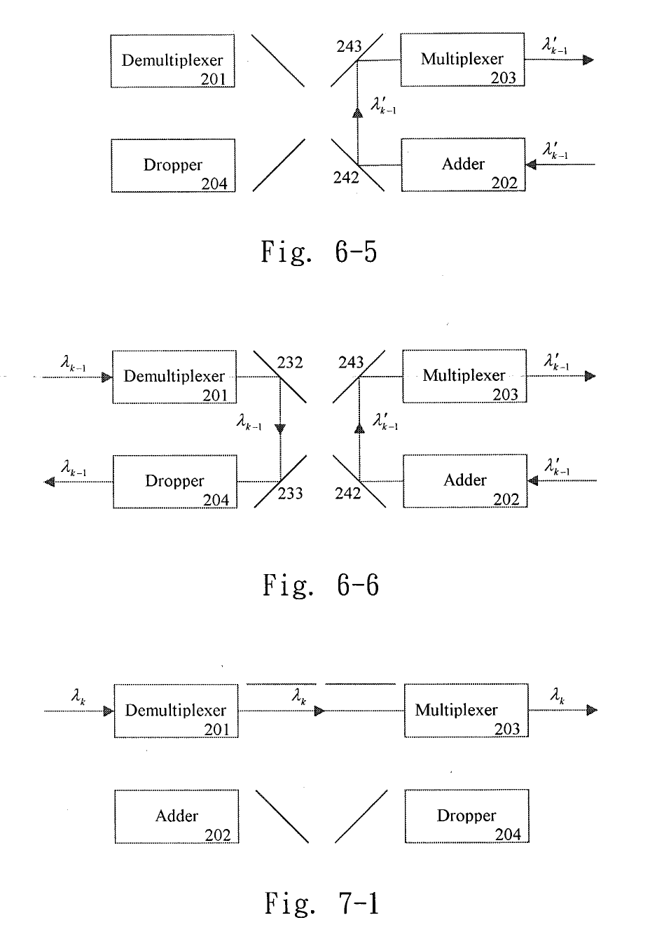

As the apparatus for optical signal processing system described in Example 1, replacing said one-dimension optical fiber arrays or the optical waveguide arrays with arrayed waveguide gratings (AWG), then it can be used as a wavelength selective optical add/drop multiplexer (OADM) or a reconfigurable optical add/drop multiplexer (ROADM). As shown in FIG. 6-1, the 3-dimensional perspective view of the multi-wavelength optical signal add-drop multiplexer is illustrated. The 1×N arrayed waveguide gratings are used as the optical signal demultiplexer 201 and the adder 202 for separating and demultiplexing optical signals, while the N×1 arrayed waveguide gratings are used as the optical signal multiplexer 203 and the dropper 204 for converging and multiplexing optical signals. The waveguide arrays 205, 206, 207, 208 with the amount of N are the output terminals of the optical signal demultiplexer 201 and the adder 202, and the input terminals of the optical signal multiplexer 203 and the dropper 204 respectively. The three-dimensional array 209 of stand-able micro-mirrors consists of four 1×N one-dimensional arrays of micro-mirrors manufactured by using the micro-electro-mechanical technology. Thus, the propagation paths of the optical signals between waveguide arrays can be changed assignably.

After a multi-wavelength optical signal is inputted to the demultiplexer 201, and separated according to its various wavelengths, the optical signals with various wavelengths are outputted from the waveguides of waveguide array 205. Then, the propagation paths of the optical signals with various wavelengths are controlled respectively by the stand-able micro-mirrors of the micro-mirror array 209, wherein, said propagation path of each optical signal of each wavelength is controlled by four micro-mirrors. Finally, the non-dropped-out wavelength optical signals are transmitted into the waveguide array 207 of the input ports of the multiplexer 203, converged together, and then outputted from one channel. The dropped-out optical signals with the expected wavelengths are transmitted into the waveguide array 208 of the input ports of the dropper 204, converged together, and then outputted from one channel. New optical signals added-in with the wavelengths of the above-mentioned dropped-out optical signals are inputted into the adder 202, separated into corresponding channels according to the wavelength difference by the adder 202, and then outputted from the waveguides of the waveguide array 206. The propagation paths are then changed by the micro-mirror array 209. Finally, said optical signals are guided into the waveguide array 207 of the input ports of the multiplexer 203, converged together with the above-mentioned non-dropped-out wavelengths optical signals, and outputted from one channel.

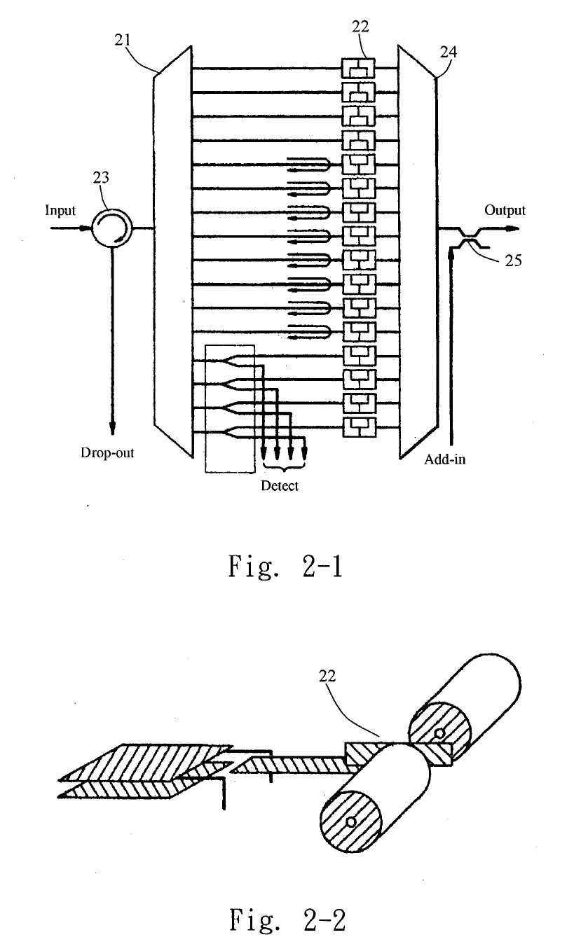

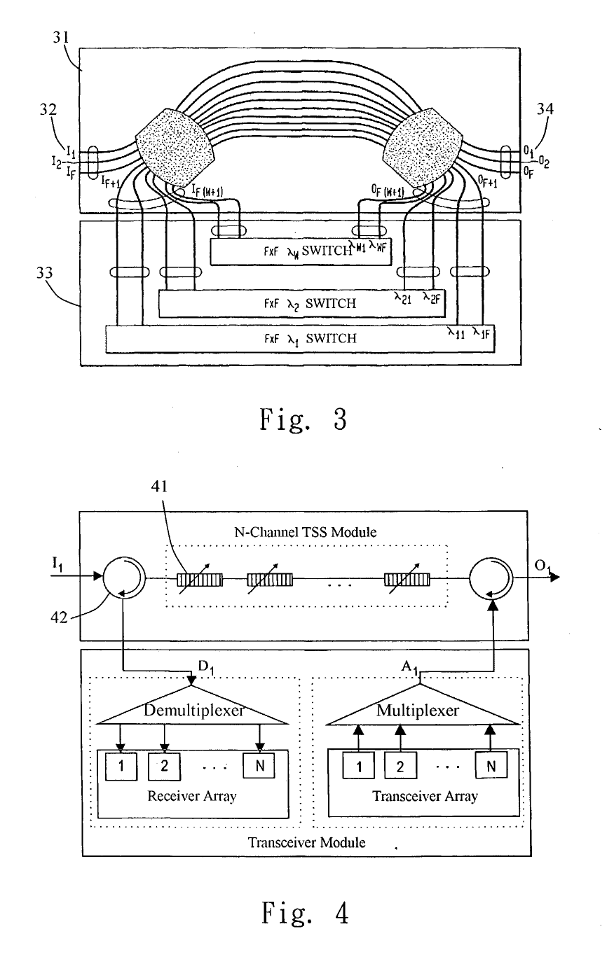

Referring to FIG. 6-2, a perspective view showing the non-dropped-out state of the k^{th} channel optical signal inside the multi-wavelength optical signal add-drop multiplexing apparatus I is illustrated. Please also refer to FIG. 6.1. After the multi-wavelength optical signal separated by the demultiplexer 201, the optical signal with wavelength λₖ is outputted from the k^{th} waveguide 211 of the waveguide array 205, passing through the two micro-mirrors 212 and 213, transmitted to the k^{th} waveguide 214 of the waveguide array 207, converged together with the other channel optical signals by the multiplexer 203, and then outputted from one channel. Wherein, the surface of the micro-mirrors 212 and 213 are parallel to the transmitting direction of the optical signal, so that the propagation path of the optical signal is unchanged. There is another propagation path of non-dropped-out optical signal, such as shown in FIG. 6-3, the perspective view showing the non-dropped-out state of the k+1^{th} channel optical signal inside the multi-wavelength optical signal add-drop multiplexing apparatus I. Please also refer to FIG. 6-1. After the multi-wavelength optical signal separated by the demultiplexer 201, the optical signal with wavelength λₖ₊₁ is outputted from the k+1^{th} waveguide 221 of the waveguide array 205, reflected sequentially by the four micro-mirrors 222, 223, 224, 225, transmitted to the k+1^{th} waveguide 226 of the waveguide array 207, converged with the other channel optical signals by the multiplexer 203, and then outputted from one channel.

Referring to FIG. 6-4, a perspective view showing the dropped-out state of the k−1^{th} channel optical signal inside the multi-wavelength optical signal add-drop multiplexing apparatus I is illustrated. Please also refer to FIG. 6.1. After the multi-wavelength optical signal separated by the demultiplexer 201, the optical signal with wavelength λₖ₋₁ is outputted from the k−1^{th} waveguide 231 of the waveguide array 205, reflected by the two micro-mirrors 232 and 233, transmitted to the k−1^{th} waveguide 234 of the waveguide array 208, converged with other dropped-out channel optical signals by the multiplexer 204, and then outputted. Referring to FIG. 6-5, a perspective view showing the new optical signal is added-into the k−1^{th} channel inside the multi-wavelength optical signal add-drop multiplexing apparatus I is illustrated. Please also refer to FIG. 6.1. After the single- or multi-wavelength optical signal, which is intended to be added-in, separated by the adder 202, the optical signal with wavelength λₖ₋₁ is outputted from the k−1^{th} waveguide 241 of the waveguide array 206, reflected by the micro-mirrors 242 and 243, transmitted to the k−1^{th} waveguide 244 of the waveguide array 207, converged together with the other channel optical signals by the multiplexer 203 and outputted. As described above, to drop-out the old signals with wavelength λₖ₋₁ and to add-in the new signals with the same wavelength, it is possible that the above-mentioned motions can be operated at the same time. As shown in FIG. 6-6, the perspective view showing the motions of adding-in the new optical signal and dropping-out the old signal at the same time is illustrated.

### EXAMPLE 3

The above-mentioned multi-wavelength optical signal add-drop multiplexing apparatus I is enabled to exchange the locations of the demultiplexer 201, the adder 202, the multiplexer 203 and the dropper 204, and thus various structures are made. The surfaces of the micro-mirrors of micro-mirror array 209 are turned to different directions from said various structures for the following processes: non-dropping-out optical signals, dropping-out original signals, and adding-in new signals.

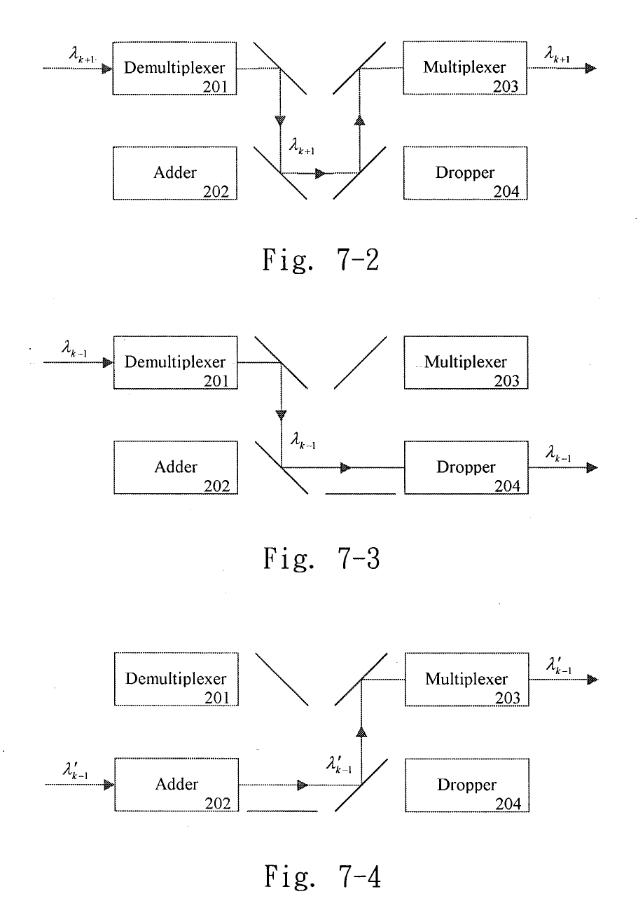

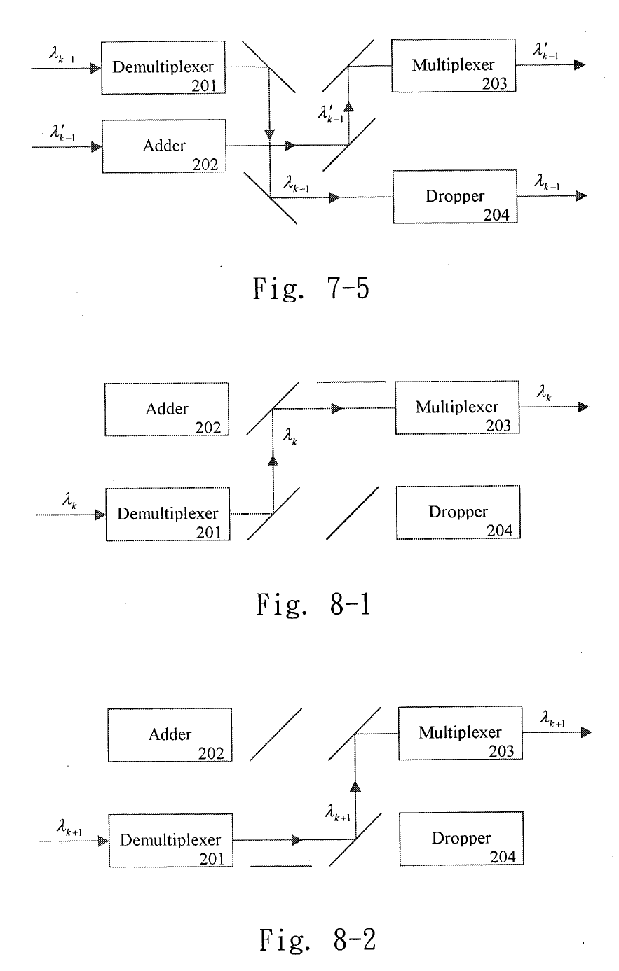

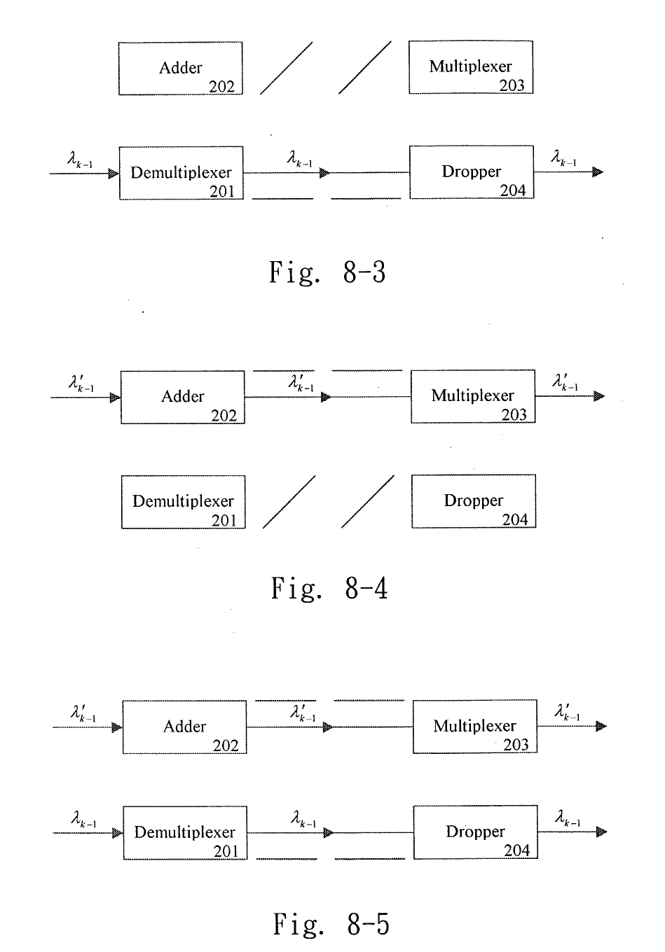

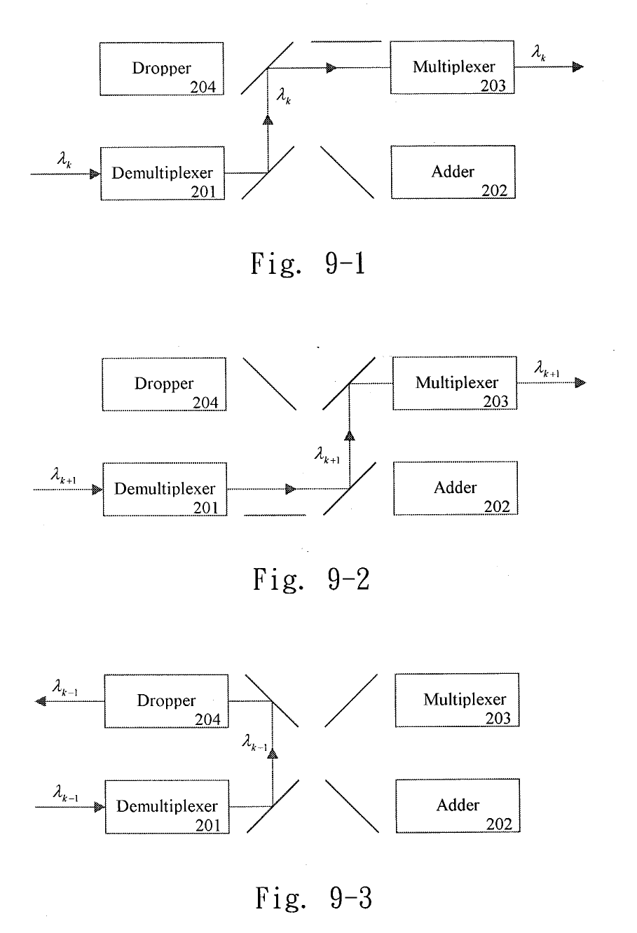

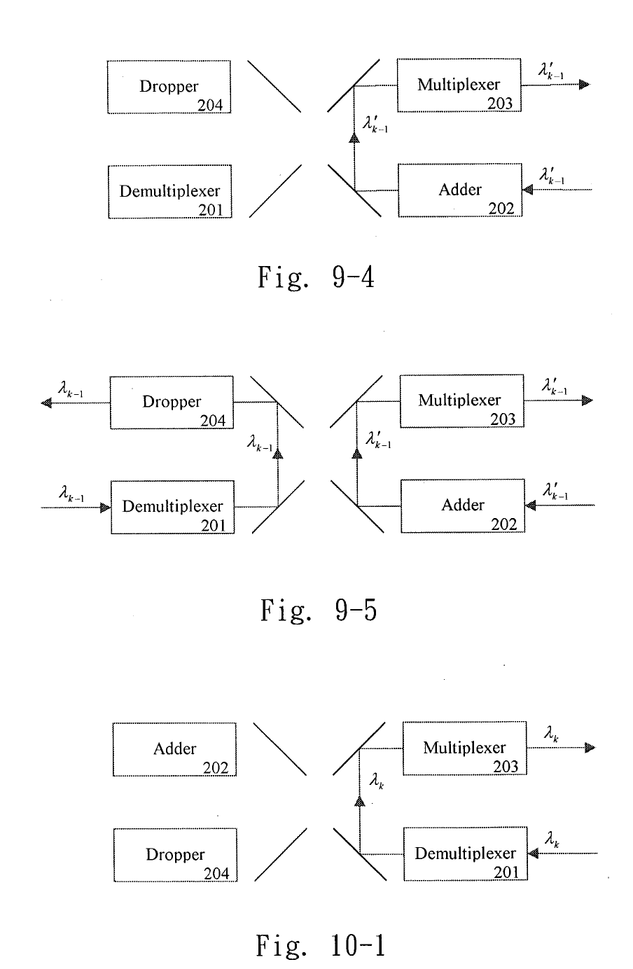

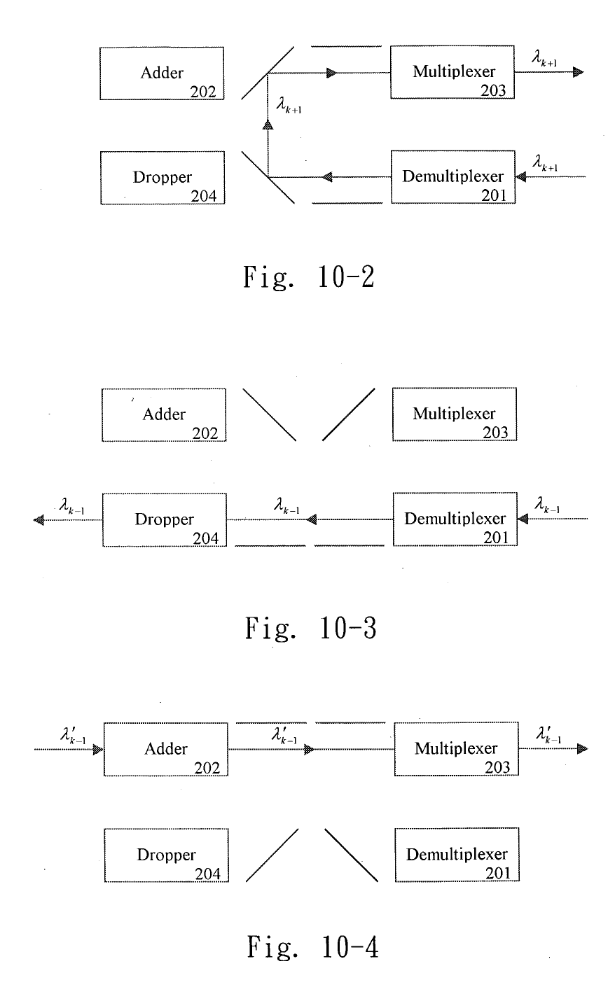

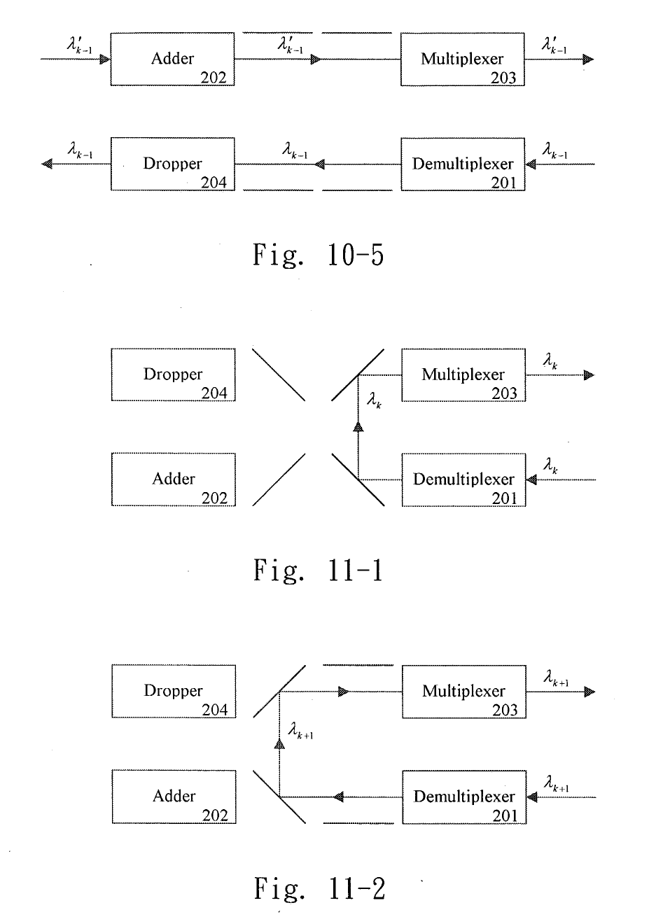

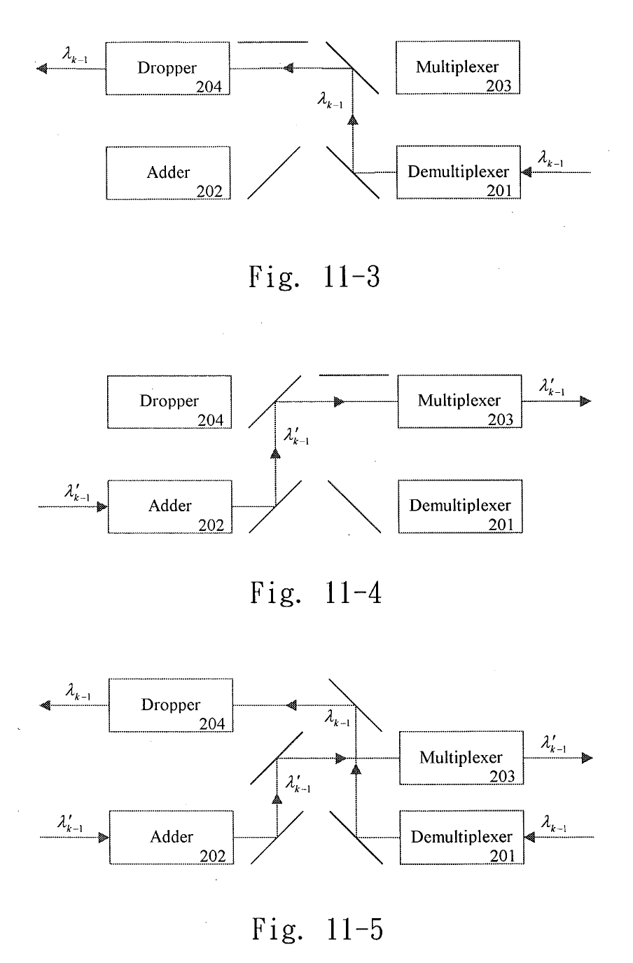

FIG. 7-1 illustrates the non-dropped-out state of the K^{th} channel optical signal inside the multi-wavelength optical signal add-drop multiplexing apparatus II. FIG. 72 illustrates the non-dropped-out state of the k+1^{th} channel optical signal inside the multi-wavelength optical signal add-drop multiplexing apparatus II. FIG. 7-3 illustrates the dropped-out state of the k−1^{th} channel optical signal inside the multi-wavelength optical signal add-drop multiplexing apparatus II. FIG. 7-4 illustrates the state of the new optical signal added-into the k−1^{th} channel inside the multi-wavelength optical signal add-drop multiplexing apparatus II. FIG. 7-5 shows the state of dropping-out the old signal and adding-in the new signal at the same time of the k−1^{th} channel inside the multi-wavelength optical signal add-drop multiplexing apparatus II. FIG. 8-1 illustrates the non-dropped-out state of the k^{th} channel optical signal inside the multi-wavelength optical signal add-drop multiplexing apparatus II. FIG. 8-2 shows the non-dropped-out state of the k+1^{th} channel optical signal inside the of the multi-wavelength optical signal add-drop multiplexing apparatus III. FIG. 8-3 illustrates the dropped-out state of the k−1^{th} channel optical signal inside the of the multi-wavelength optical signal add-drop multiplexing apparatus III. FIG. 8-4 illustrates the state of the new optical signal added-into the k−1^{th} channel inside the multi-wavelength optical signal add-drop multiplexing apparatus III. FIG. 8-5 shows the state of dropping-out the old signal and adding-in the new signal at the same time of the k−1^{th} channel inside the multi-wavelength optical signal add-drop multiplexing apparatus III. FIG. 9-1 illustrates the non-dropped-out state of the K^{th} channel optical signal inside the of the multi-wavelength optical signal add-drop multiplexing apparatus IV FIG. 9-2 illustrates the non-dropped-out state of the k+1^{th} channel optical signal inside the of the multi-wavelength optical signal add-drop multiplexing apparatus IV FIG. 9-3 shows the dropped-out state of the k−1^{th} channel optical signal inside the of the multi-wavelength optical signal add-drop multiplexing apparatus IV FIG. 9-4 shows the state of the new optical signal added-into the k−1^{th} channel inside the multi-wavelength optical signal add-drop multiplexing apparatus IV FIG. 9-5 shows the state of dropping-out the old signal and adding-in the new signal at the same time of the k−1^{th} channel inside the multi-wavelength optical signal add-drop multiplexing apparatus IV FIG. 10-1 shows the non-dropped-out state of the k^{th} channel optical signal inside the multi-wavelength optical signal add-drop multiplexing apparatus V FIG. 10-2 shows the non-dropped-out state of the k+1^{th} channel optical signal inside the multi-wavelength optical signal add-drop multiplexing apparatus V FIG. 10-3 shows the dropped-out state of the k−1^{th} channel optical signal inside the of the multi-wavelength optical signal add-drop multiplexing apparatus V FIG. 10-4 shows the state of the new optical signal added-into the k−1^{th} channel inside the multi-wavelength optical signal add-drop multiplexing apparatus V FIG. 10-5 shows the state of dropping-out the old signal and adding-in the new signal at the same time of the k−1^{th} channel inside the multi-wavelength optical signal add-drop multiplexing apparatus V FIG. 11-1 shows the non-dropped-out state of the k^{th} channel optical signal inside the multi-wavelength optical signal add-drop multiplexing apparatus VI. FIG. 11-2 shows the non-dropped-out state of the k+1^{th} channel optical signal inside the multi-wavelength optical signal add-drop multiplexing apparatus VI. FIG. 11-3 shows the dropped-out state of the k−1^{th} channel optical signal inside the of the multi-wavelength optical signal add-drop multiplexing apparatus VI. FIG. 11-4 shows the state of the new optical signal added-into the k−1^{th} channel inside the multi-wavelength optical signal add-drop multiplexing apparatus VI. FIG. 11-5 shows the state of dropping-out the old signal and adding-in the new signal at the same time of the k−1^{th} channel inside the multi-wavelength optical signal add-drop multiplexing apparatus VI.

### EXAMPLE 4

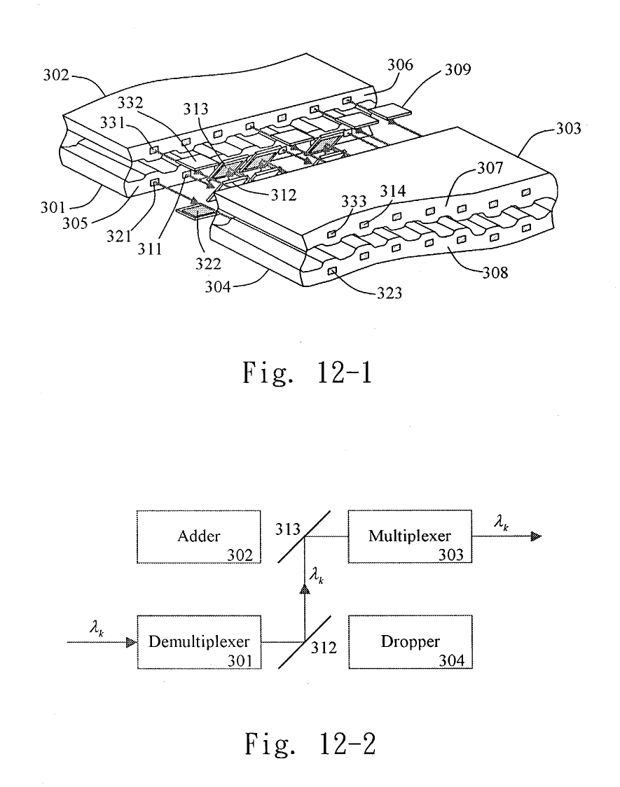

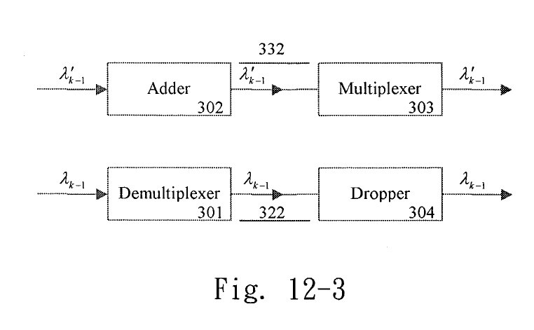

As described in Example 3, the multi-wavelength optical signal add-drop multiplexing apparatus III is enabled to reduce the amount of stand-able micro-mirrors of the micro-mirror array. The transmitting direction of each optical signal is just controlled by two micro-mirrors. As FIG. 12-1 shows, a 3-dimensional perspective view showing the multi-wavelength optical signal add-drop multiplexing apparatus VII is illustrated. The arrayed waveguide gratings (AWG) are applied as the demultiplexer 301, the adder 302, the multiplexer 303 and the dropper 304, and the waveguide arrays 305, 306, 307, 308 with the amount of N are the output terminals of the optical signal demultiplexer 301 and the adder 302, and the input terminals of the optical signal multiplexer 303 and the dropper 304 respectively. The micro-mirror array 309 is manufactured by using the micro-electro-mechanical technology, and consists of two 1×N one-dimension arrays of stand-able micro-mirrors.

FIG. 12-2 shows a perspective view of the non-dropped-out state of the k^{th} channel optical signal inside the multi-wavelength optical signal add-drop multiplexing apparatus VII. Please also refer to FIG. 12-1. After the multi-wavelength optical signal separated by the demultiplexer 301, the optical signal with wavelength λₖ is outputted from the k^{th} waveguide 311 of the waveguide array 305, reflected by the micro-mirrors 312 and 313, transmitted to the k^{th} waveguide 314 of the waveguide array 307, then converged together with the other channel optical signals by the multiplexer 303, and outputted from one channel.

FIG. 12-3 shows the state of dropping-out the old signal and adding-in the new signal at the same time of the k−1^{th} channel inside the multi-wavelength optical signal add-drop multiplexing apparatus VII. Please also refer to FIG. 12-1, after the multi-wavelength optical signal separated by the demultiplexer 301, the optical signal with wavelength λₖ₋₁ is outputted from the k−1^{th} waveguide 321 of the waveguide array 305, reflected by the micro-mirror 322, then transmitted into the k−1^{th} waveguide 323 of the waveguide array 308, and dropped-out after converged or multiplexed with the other optical signals that are also dropped-out. Wherein, the surface of the micro-mirror 322 is parallel to the transmitting direction of the optical signal so that the propagation path is unchanged. Furthermore, after the new signal with single- or multi-wavelength intended to be added-in is demultiplexed or separated by the adder 302, the new signal with wavelength λk−1 is outputted from the k−1^{th} waveguide 331 of the waveguide array 306, then reflected by the micro-mirror 332, transmitted into the k−1^{th} waveguide 333 of the waveguide array 307, converged with the optical signals from other channels, and outputted. The above-mentioned states of dropping-out the old signal with wavelength λₖ₋₁ and adding-in the new signal with the same wavelength can be operated separately, or just only the former one is operated and the latter one is not operated.

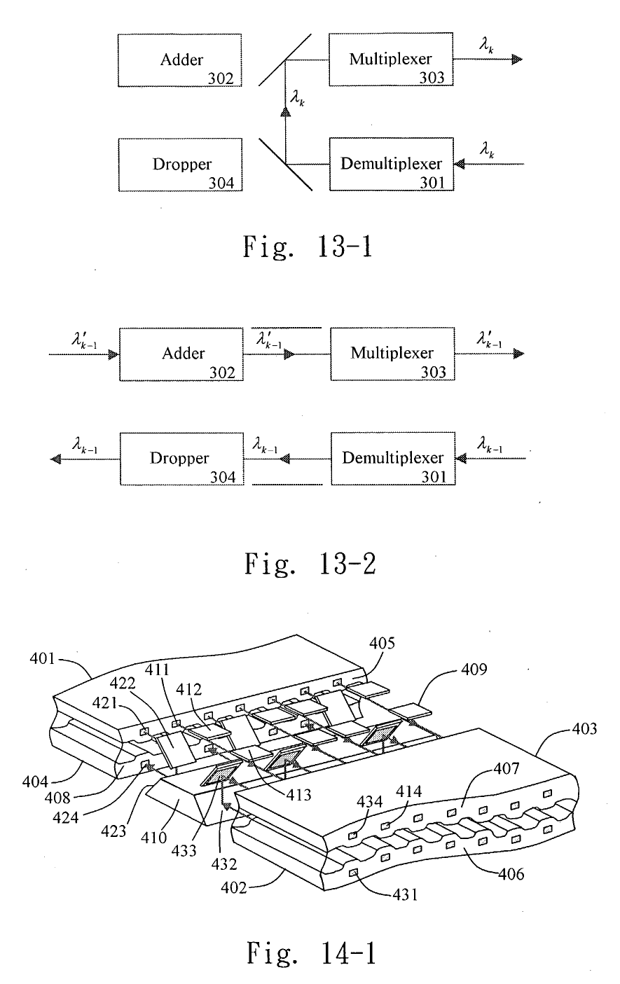

As described in Example 3, the multi-wavelength optical signal add-drop multiplexing apparatus V is also enabled to reduce the amount of stand-able micro-mirrors of the micro-mirror array. The transmitting direction of each optical signal is just controlled by two micro-mirrors. FIG. 13-1 shows a perspective view of the non-dropped-out state of the k^{th} channel optical signal inside the multi-wavelength optical signal add-drop multiplexing apparatus VIII. FIG. 13-2 shows a perspective view of the state of dropping-out the old signal and adding-in the new signal at the same time of the k−1^{th} channel inside the multi-wavelength optical signal add-drop multiplexing apparatus VIII.

### EXAMPLE 5

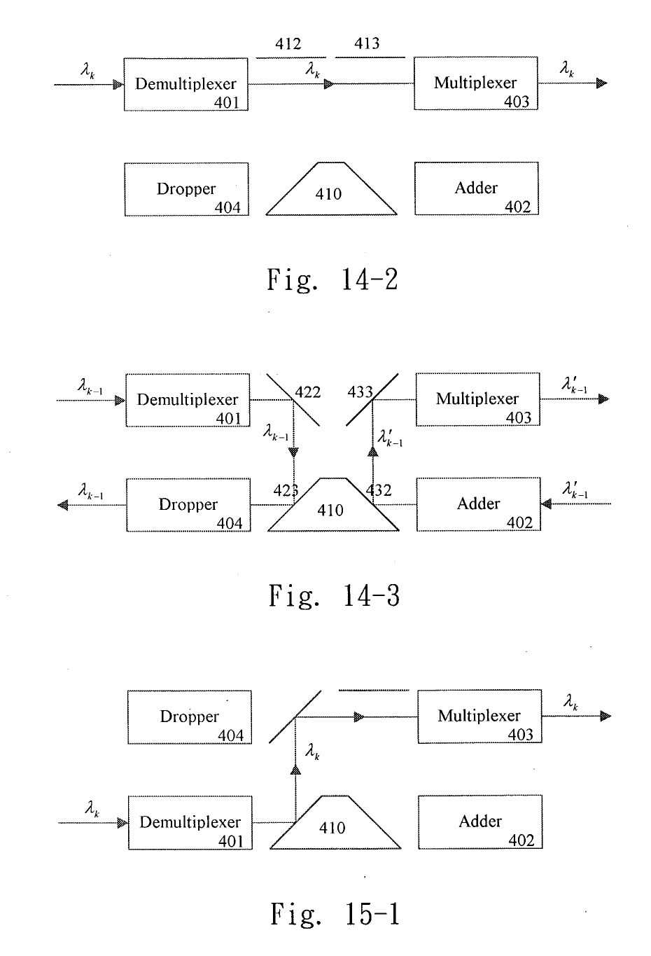

The above-mentioned multi-wavelength optical signal add-drop multiplexing apparatus I in Example 2, wherein the 2N micro-mirrors of the micro-mirror array can be replaced by two fixed reflective mirrors. As shown in FIG. 14-1, a 3-dimensional perspective view of the multi-wavelength optical add-drop multiplexing apparatus IX is illustrated. Wherein, a mesa 410 manufactured by using the silicon micro-processing technology is applied as the two fixed reflective mirrors. The arrayed waveguide gratings (AWG) are applied as the demultiplexer 401, the adder 402, the multiplexer 403 and the dropper 404, and the waveguide arrays 405, 406, 407, 408 with the amount of N are the output terminals of the optical signal demultiplexer 401 and the adder 402, and the input terminals of the optical signal multiplexer 403 and the dropper 404 respectively. The stand-able micro-mirror array 409 can be manufactured by micro-electro-mechanical technology.

FIG. 14-2 shows a perspective view of the non-dropped-out state of the k^{th} channel optical signal inside the multi-wavelength optical signal add-drop multiplexing apparatus VII. Please also refer to FIG. 14-1. After the multi-wavelength optical signal separated by the demultiplexer 401, the optical signal with wavelength λₖ is outputted from the k^{th} waveguide 411 of the waveguide array 405, reflected by the micro-mirrors 412 and 413, then transmitted to the k^{th} waveguide 314 of the waveguide array 407, converged with the other channel optical signals by the multiplexer 403, and outputted from one channel. Wherein, the surfaces of the micro-mirrors 412, 413 are parallel to the transmitting direction of the optical signal so that the propagation path is unchanged.

FIG. 14-3 shows the state of dropping-out the old signal and adding-in the new signal at the same time of the k−1^{th} channel inside the multi-wavelength optical signal add-drop multiplexing apparatus IX. Please also refer to FIG. 14-1. After the multi-wavelength optical signal separated by the demultiplexer 401, the optical signal with wavelength λₖ₋₁ is outputted from the k−1^{th} waveguide 421 of the waveguide array 405, reflected by the micro-mirror 422 and the fixed reflective mirror 423, then transmitted to the k−1^{th} waveguide 424 of the waveguide array 408, and dropped-out by the dropper 404 after multiplexed or converged with the other optical signals that are also dropped-out. After the new optical signal intended to be added-in with single- or multi-wavelength separated by the adder 402, the new signal with wavelength λₖ₋₁ is outputted from the k−1^{th} waveguide 431 of the waveguide array 406, reflected by the stand-able micro-mirror 432 and the fixed reflective mirror 433, then transmitted into the k−1^{th} waveguide 434 of the waveguide array 407, converged with the optical signals from other channels by the multiplexer 403, and outputted. The above-mentioned state of dropping-out the old signal with wavelength λₖ₋₁ and adding-in the new signal with the same wavelength can be operated separately, or just only the former one is operated and the latter one is not operated.

As described in Example 3, the multi-wavelength optical signal add-drop multiplexing apparatus IV, the 2N micro-mirrors of the micro-mirror array can also be replaced by two fixed reflective mirrors. FIG. 15-1 shows a perspective view of the non-dropped-out state of the k^{th} channel optical signal inside the multi-wavelength optical signal add-drop multiplexing apparatus X. FIG. 15-2 shows a perspective view of the state of dropping-out the old signal and adding-in the new signal at the same time of the k−1^{th} channel inside the multi-wavelength optical signal add-drop multiplexing apparatus X.

### EXAMPLE 6

Referring to the above-mentioned multi-wavelength optical signal add-drop multiplexing apparatuses in Examples 2 through 5 as shown in FIG. 16, a perspective view of a 4-wavelength optical signal add-drop multiplexing apparatus is illustrated. The demultiplexer 501 and the adder 502 are 1×4 arrayed waveguide gratings (AWG). The multiplexer 503 and the dropper 504 are 4×1 arrayed waveguide gratings. The 1^{st} to 4^{th} 1×4 one-dimension micro-mirror arrays 505 to 508 consist of stand-able micro-mirror structures manufactured by the micro-electro-mechanical technology.

After the 4-wavelength optical signal (contains four wavelengths: λ₁, λ₂, λ₃, λ₄) transmitted through the demultiplexer 501, it is separated according to the difference of wavelengths and guided sequentially to four different channels and transmitted into the 1^{st} 1×4 one-dimension micro-mirror array 505. The 1^{st} 1×4 one-dimension micro-mirror array 505 consists of four independent micro-mirrors to control the propagation paths of the optical signals from the four channels respectively. Then, the optical signals with wavelength λ₂, λ₃, λ₄, that intended to be dropped-out, are transmitted to the 2^{nd} 1×4 one-dimension micro-mirror array 506, inputted into the dropper 504, then converged or multiplexed together and finally outputted by one channel. The optical signal with the wavelength λ₁ is transmitted to the 3^{rd} 1×4 one-dimension micro-mirror array 507. New optical signals that intended to be added-in with the wavelengths, are inputted from the adders 502, and separated into the 2^{nd}, 3^{rd} channels by the adders 502. Then the two optical signals are reflected by the 4^{th} 1×4 one-dimension micro-mirror array 508, and also transmitted to the 3^{rd} 1×4 one-dimension micro-mirror array 507. After the optical signal with wavelength λ₁ and new added-in optical signals with wavelengths λ₂, λ₃ are transmitted to the 3^{rd} 1×4 one-dimension micro-mirror array 507, they are transmitted into and converged by the multiplexer 503, and then outputted from one channel.

### EXAMPLE 7

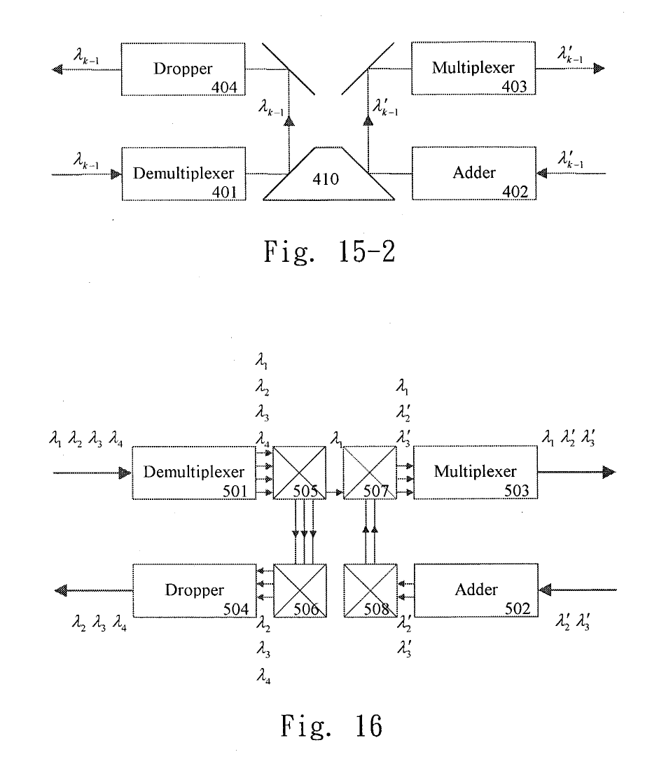

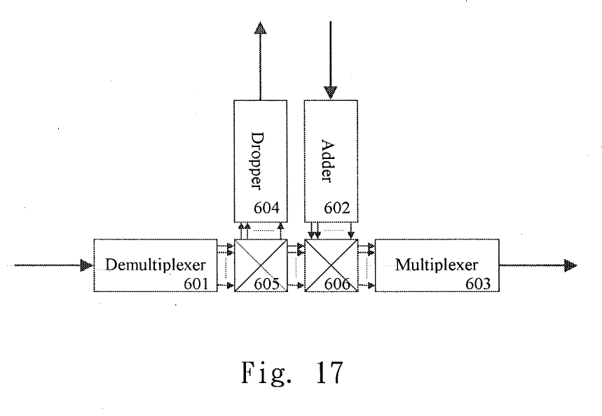

Referring to the above-mentioned multi-wavelength optical signal add-drop multiplexing apparatuses in Examples 2 through 5, the locations of the demultiplexer, the adder, the multiplexer, the dropper can be exchanged, and the framework between the above-mentioned components and the micro-mirror arrays can also be changed to achieve different functions: non-dropping-out optical signals, dropping-out original signals, and adding-in new signals. As shown in FIG. 17, the perspective view of another structure of the multi-wavelength optical signal add-drop multiplexing apparatus is illustrated. After the optical signal with multi-wavelength entered the demultiplexer 601, the transmitting path of each wavelength optical signal is controlled by the one-dimension micro-mirror arrays 605, 606, respectively. The wavelength optical signals that intended to be dropped-out are transmitted into the dropper 604, converged, and outputted from one channel immediately. The wavelength optical signals that are not dropped-out are transmitted into the multiplexer 603, converged, and then outputted from one channel finally. The new optical signals, intended to be added-in with the wavelengths of dropped-out optical signals, are inputted into and separated by the adder 602, then reflected by one-dimension micro-mirror array 606, transmitted into the multiplexer 603, converged with the above-mentioned optical signals that are not dropped-out, and outputted from one channel finally. Many other variations would be possible without departing from the basic approach and demonstration in the present invention.

### EXAMPLE 8

Referring to the apparatuses for optical signal processing system as described from Examples 1 to 7, the whole apparatus can be divided into to two layers of the upper layer and the lower layer approximately, and all the components can be applied and manufactured onto two substrates. The two substrates are fixed together by a packaging process, and at the same time, other active or passive photoelectric components are applied selectively to the substrates. The whole manufacturing process of the apparatus for optical signal processing system is completed.

FIG. 18 shows the perspective view of the embodiment, wherein the apparatus for optical signal processing system is prepared to two substrates. The input terminal optical fiber 711, the optical signal demultiplexer 712, the micro-mirror array 713, the optical signal multiplexer 714, and the output terminal optical fiber 715 are prepared onto the silicon substrate 701. Wherein, the optical signal demultiplexer 712 and the optical signal multiplexer 714 can be manufactured by arrayed waveguide grating technology. The micro-mirror array 713 consists of two one-dimension micro-mirror arrays 721, 722 manufactured by using the micro-electro-mechanical technology. Furthermore, V-shaped or U-shaped groove arrays on the substrate or carrier substrate made by well-known micromachining technology is applied to help the fiber alignment and assembly work in a very precise manner. The silicon substrate 702 is manufactured by the same or similar methods. The two silicon substrates 701, 702 are fixed or bonded together by the packaging process, and then the apparatus for optical signal processing system 703 is accomplished.

### EXAMPLE 9

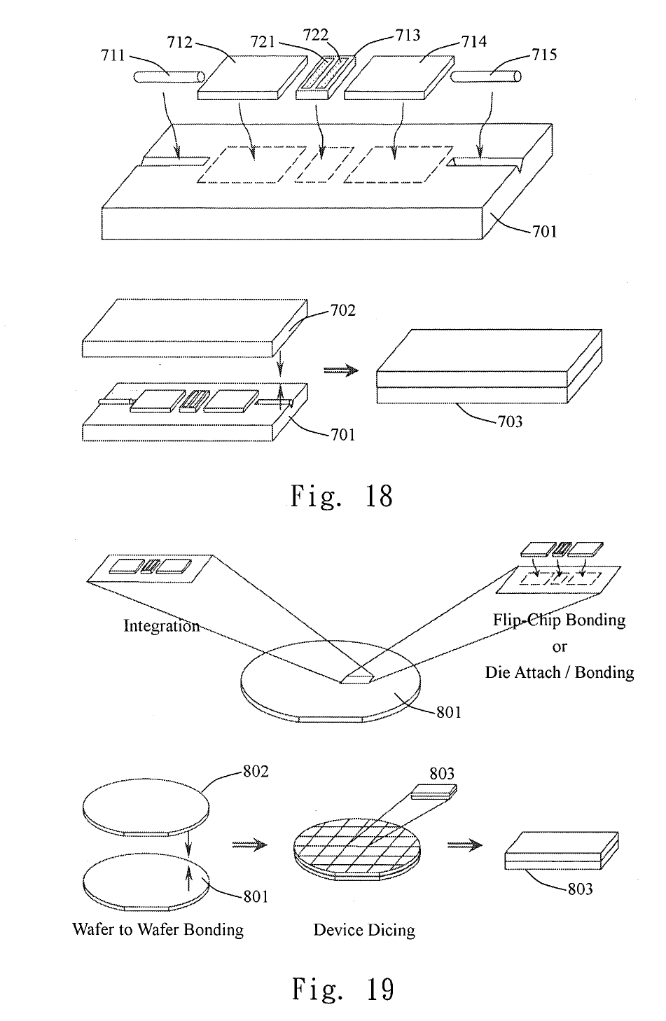

As the Example 8 described above, the apparatus for optical signal processing system is applied to two substrates, and the two substrates are fixed or bonded together by the packaging process. Since the manufacturing processes of the components are wafer level processes, the first-level package in the wafer stage can be completed by using the wafer level package technology such as the wafer to wafer bonding, the flip-chip bonding, and the die attach/bonding etc. As shown in FIG. 19, all the devices of the apparatus for optical signal processing system are integrated or hybrid assembled by the above-mentioned technology of flip-chip bonding or die attach/bonding onto the wafer 801. And the wafer 802 is manufactured by the same or similar method. Afterwards, the wafers 801, 802 are bonded together by the above-mentioned technology of wafer to wafer bonding. Then the bonded wafers of numerous apparatuses can be dicing into discrete apparatus. Finally, the aligning and sealing process of the optical fibers and the exterior packaging process are proceeding, and the whole housing process are accomplished. The apparatus for optical signal processing system manufactured by this method is the same as the one in the Example 8 described above.

According to the apparatus for optical signal processing system of the present invention, wherein, the optical fiber arrays or optical planar waveguide arrays are used as the input terminal and the output terminal of multiple optical signals. Moreover, 1×N one-dimensional stand-able micro-mirror arrays manufactured by using the MEMS technology are applied to change the transmitting directions of the optical signal of each channel between the input terminals and the output terminals, thus, it achieves the purpose of switching the optical signals from one channel of input terminals to another corresponding channel of output terminals.

Moreover, let the first pair of input and output terminals be used as the device for handling the on-going traffic signals, and the second pair of input and output terminals as the adding ports of new signals into present traffic and the dropping ports of signals to be terminated in current traffic. Thus, the optical signals of different channels can be individually transmitted to output terminal or can be independently dropped, while new signals can be individually added into corresponding channels of output terminal of first pair via the adding ports of second pair of terminals. Therefore the optical signals can be added in or dropped from traffic independently for each channel. Furthermore, the action of dropping-out the optical signal and adding-in new optical signal can be executed simultaneously for one channel. Thus, it is capable of preventing adding new optical signal into the channel of which the optical signal has not been dropped-out. If the above-mentioned optical fiber arrays or optical planar waveguide arrays are replaced or combined with arrayed waveguide gratings (AWG) as multiplexers and demultiplexers, this apparatus can be applied as a wavelength selective optical add/drop multiplexer (OADM), or a reconfigurable optical add/drop multiplexer (ROADM).

Furthermore, the apparatus for optical signal processing system can be accomplished by a batch-type wafer level process, based on the known micromachining, microfabrication, flip-chip bonding, die bonding, and wafer level packaging technologies. The apparatus for optical signal processing system of the present invention is not only different from the known technics, but it is simply designed, easily manufactured, fewer components applied and lower cost consumed comparatively. The above-mentioned advantages are not seen from the conventional technics. Although the present invention has been described using specified embodiment, the examples are meant to be illustrative and not restrictive. It is clear that many other variations would be possible without departing from the basic approach, demonstrated in the present invention.

### REFERENCE MATERIALS

(1) Olav Solgaard, Jonathan P. Heritage, Amal R. Bhattarai, “Multi-Wavelength Cross-Connect Optical Switch”, U.S. Pat. No. 6,097,859 (2000)

(2) Vladimir A. Aksyuk, Bradley P. Barber, David J. Bishop, Clinton R. Giles, Lawrence W. Stulz, Rene R. Ruel, “Wavelength Division Multiplexed Optical Networks”, U.S. Pat. No. 6,148,124 (2000)

(3) Weyl-Kuo Wang, Franklin Fuk-Kay Tong, Karen Liu, “Wavelength Sorter and its Application to Planarized Dynamic Wavelength Routing”, U.S. Pat. No. 5,745,612 (1998)

(4) Karen Liu, Weyl-Kuo Wang, Chaoyu Yue, “Dynamic Optical Add-Drop Multiplexers and Wavelength-Routing Networks with Improved Survivability and Minimized Spectral Filtering”, U.S. Pat. No. 5,953,141 (1999)

(5) Karen Liu, Weyl-Kuo Wang, Chaoyu Yue, “Dynamic Optical Add-Drop Multiplexers and Wavelength-Routing Networks with Improved Survivability and Minimized Spectral Filtering”, U.S. Pat. No. 6,208,443 B1 (2001)

(6) Daniel H. Raguin, Geoffrey Gretton, Don Mauer, Emil Piscani, Eric Prince, Tasso R. M. Sales, Don Schertler, “Anamorphic and aspheric microlenses and microlens arrays for telecommunication applications”, Optical Fiber Communication Conference, Mar. 17-22, 2001, Anaheim, Calif.

(7) King C. R., Lin L. Y., Wu M. C., “Out-of-plane refractive microlens fabricated by surface micromachining”, IEEE Photon. Tech. Lett. 8, 1349-1351 (1996)

(8) M. Edward Motamedi, Ming, C. Wu, Kristofer S. J. Pister, “Micro-opto-electromechanical devices and on-chip optical processing”, Opt. Eng. 36(5), 1282-1297 (1997)

(9) Lin L. Y., Lee S. S., Pister K. S. J., Wu M. C. “Three-dimensional micro-Fresnel optical elements fabricated by micromachining techniques”, Elect. Lett. 30, 448449 (1994)

(10) URL: http://www.memsrus.com/svcsmumps.html

What is claimed is:

1. An apparatus for optical signal processing system, comprising:
At least an optical input terminal of an one-dimensional array of waveguides used as the input ports for multiple optical signals with various wavelengths in which these optical signals may need to be switched to corresponding output ports;
At least an optical output terminal of an one-dimensional array of waveguides used as the output ports for multiple optical signals with various wavelengths in which transmitting paths of these optical signals might have been experienced with the operation of re-direction and switching;
At least an one-dimensional array of micro-mirrors manufactured by using the micro-electro-mechanical technology for switching and re-directing the transmitting directions of each individual optical signals for each channels between the said optical input terminals and said optical output terminals;

2. The apparatus for optical signal processing system of claim 1, wherein the said waveguides can be the optical planar waveguide elements and optical fibers.

3. The apparatus for optical signal processing system of claim 1, wherein the said waveguides can partially be the optical planar waveguide elements, while the rest part of waveguides is an array of optical fibers.

4. The apparatus for optical signal processing system of claim 1, wherein the said waveguides can be aligned, assembled and fixed onto substrates and carrier substrates with micromachined V-shaped and U-shaped grooves; wherein the said waveguides and apparatus can be aligned, assembled, fixed and packaged with the aids of V-shaped and U-shaped grooves, microstructures of mesa, and self-alignment process contributed by the surface tension of the solder materials.

5. The apparatus for optical signal processing system of claim 1, wherein the said micro-mirrors can be driven based on known actuation schemes including thermal, thermoelectrical, electro-thermal, electro-static, electromagnetic, magnetic, piezoelectric, air pressure difference, and hydraulic pressure difference.

6. The apparatus for optical signal processing system of claim 1, wherein the said one-dimensional array of micro-mirrors can be optionally replaced by reflective mirrors with fixed facet angle manufactured by micrmachining, microfabrication, or electroplating technologies; wherein the said one-dimensional array of micro-mirrors can be optionally replaced by optical fibers and optical planar waveguides with 45° facet end; such that the transmitting directions of said optical signals will be changed in a fixed deflection angles.

7. The apparatus for optical signal processing system of claim 1, wherein one of the said optical input terminal of an one-dimensional array of waveguides can be the 1×N arrayed waveguide grating which acts as an optical signal demultiplexer, such that the input optical signals with multiple wavelengths from a single channel of the input terminal are separated and demultiplexed, according to its wavelength difference, and then transmitted to each corresponding optical channels.

8. The apparatus for optical signal processing system of claim 1, wherein one of the said optical input terminal of an one-dimensional array of waveguides can be used as the adding ports of new optical signals with specific wavelengths into current traffic, after the optional operation of transmitting direction adjustment of these optical signals by using micro-mirrors, then these add-in new signals can be individually transmitted into corresponding output channels depending on their relative wavelengths. Therefore the optical signals can be added into traffic independently for each channel.

9. The apparatus for optical signal processing system of claim 1, wherein a part of channels of the said an one-dimensional array of waveguides of input terminal can be input ports for handling the existing optical signals of on-going traffic, while the rest part of channels can be adding ports for originating new optical signals with specific wavelengths into current traffic.

10. The apparatus for optical signal processing system of claim 1, wherein one of the said optical output terminal of an one-dimensional array of waveguides can be used as the termination ports of optical signals existing in present traffic which are need to be dropped out, where these optical signals may need the operation of transmitting direction adjustment by using micro-mirrors to help themselves switch from the corresponding output terminal to drop terminal. Thus the optical signals of different channels can be independently dropped.

11. The apparatus for optical signal processing system of claim 1, wherein a part of channels of the said an one-dimensional array of waveguides of output terminal can be output ports for handling the existing optical signals of on-going traffic, while the rest part of channels can be dropping ports for terminating optical signals with specific wavelengths from current traffic.

12. The apparatus for optical signal processing system of claim 1, wherein one of the said optical output terminal of an one-dimensional array of waveguides can be the N×1 arrayed waveguide grating which acts as an optical signal multiplexer, such that the output optical signals with multiple wavelengths after the optional operation of transmitting direction adjustment of these optical signals by using micro-mirrors can be converged and multiplexed to form a multi-wavelength optical signal in single output terminal.

13. The apparatus for optical signal processing system of claim 1, wherein the said one-dimensional array of waveguides of input terminals can be further connected with a demultiplexer using an 1×N arrayed waveguide grating, fiber gratings, or thin film filters. Thus the input optical signals with multiple wavelengths from a single input terminal will be separated and demultiplexed into several signals, and these demultiplexed signals will transmit in the said one-dimensional array of waveguides with a way that each channel has optical signals of one specific wavelength.

14. The apparatus for optical signal processing system of claim 1, wherein the said one-dimensional array of waveguides of output terminals can be further connected with a multiplexer using a N×1 arrayed waveguide grating, fiber gratings, or thin film filters. Thus the output optical signals with various wavelengths from each channels of the said one-dimensional array of waveguides will be converged and multiplexed into a set of optical signals with multiple optical wavelengths, and thereafter these multiplexed signals will transmit in a single output terminal.

15. The apparatus for optical signal processing system of claim 1, where optical devices and elements can enhance the optical transmission efficiency or optical coupling efficiency at the interface of input and output among every discrete functional optical, optoelectrical, optomechanical, and micro-electro-mechanical elements; wherein the said optical devices and elements can be each type of collimating lens; wherein the said optical devices and elements can be collecting lens such as ball lens, cylindrical lens, and refractive micro-lens; wherein the said optical devices and elements can be diffractive micro-lens such as Fresnel lens, and non-spherical lens.

16. The apparatus for optical signal processing system of claim 1, wherein the said apparatus can be prepared in separated substrates, during the manufacturing process the electrical, optoelectrical, optical, microelectromechanical types of active devices and passive devices can be selectively die bonded, flip-chip bonded, or die attached on to aforementioned substrates, then these substrates are fixed or bonded together by the known micromachining and packaging technologies. The above-mentioned apparatus and devices and elements can be aligned, assembled and packaged with the aids of V-shaped and U-shaped grooves, microstructures of mesa, self-alignment process contributed by the surface tension of the solder materials.

17. The apparatus for optical signal processing system of claim 1, wherein the said apparatus can be prepared in separated substrates, wherein materials of the said substrates can be semiconductors, glass, metals, or polymers.

18. The apparatus for optical signal processing system of claim 1, wherein the said apparatus can be prepared in separated wafers, during the manufacturing process the electrical, optoelectrical, optical, microelectromechanical types of active devices and passive devices can be selectively die bonded, flip-chip bonded, or die attached on to aforementioned wafers, then the said apparatus can be made by bonding separated wafers together; where all the functional elements are hybrid assembled or integrated onto these wafers via using the known micromachining, microfabrication, wafer level packaging, flip-chip bonding, multi-chip module technologies; then the bonded wafers of numerous apparatus can be diced or separated into discrete devices or apparatus; finally the aligning and sealing process of the optical fibers or arrayed waveguides are proceeded. The above-mentioned apparatus and devices and elements can be aligned, assembled and packaged with the aids of V-shaped and U-shaped grooves, microstructures of mesa, self-alignment process contributed by the surface tension of the solder materials; wherein materials of the said wafers can be semiconductors, glass, or polymer.

19. An apparatus for optical signal processing system, comprising:
At least an optical input terminal of an one-dimensional array of waveguides;
At least an optical output terminal of an one-dimensional array of waveguides;
A plurality of one-dimensional arrays of micro-mirrors manufactured by using the micro-electro-mechanical technology for switching and re-directing the transmitting directions of each individual optical signals for each channels between the said optical input terminals and said optical output terminals;
wherein a part of channels of the said waveguides of a single input terminal or of plural input terminals can be input ports for handling the existing optical signals of on-going traffic, while the rest part of channels of the said waveguides of a single input terminal or of plural input terminals can be adding ports for originating new optical signals with specific wavelengths into current traffic;
wherein a part of channels of the said waveguides of a single output terminal or of plural output terminals can be output ports for handling the existing optical signals of on-going traffic, while the rest part of channels of the said waveguides of a single output terminal or of plural output terminals can be dropping ports for terminating optical signals with specific wavelengths from current traffic;
wherein the said plural one-dimensional arrays of micro-mirrors are used for changing and re-directing the transmitting directions of the said optical signal among the corresponding reflective mirrors of different arrays. Thus optical signals belonging to respective channels can be switched from input channels or adding channels to output channels or dropping channels. By using this method, the optical add and drop functions can be independently controlled and done for each channels. In this way, the claimed apparatus is an optical add/drop system.

20. The apparatus for optical signal processing system of claim 19, wherein the said adding and dropping channels or ports are adder and dropper of OADM devices in optical networks of the said optical communication systems; whereas new signals can be add into signal traffic through the adder, and signals can be terminated from current signal traffic via dropper.

21. The apparatus for optical signal processing system of claim 19, wherein a set of demultiplexed or separated WDM (wavelength division multiplexing) signals can be transmitted through a part of channels of the said an one-dimensional array of waveguides of input terminals; wherein a set of output optical signals with multiple wavelengths after the optional operation of transmitting direction adjustment of these optical signals by using micro-mirrors can be converged and multiplexed into a part of channels of the said an one-dimensional array of waveguides of output terminals; In this way, the claimed apparatus is a optical add/drop multiplexer (OADM).

22. The apparatus for optical signal processing system of claim 19, wherein the said waveguides can be the optical planar waveguide elements and optical fibers;

23. The apparatus for optical signal processing system of claim 19, wherein the said waveguides can partially be the optical planar waveguide elements, while the rest part of waveguides is an array of optical fibers.

24. The apparatus for optical signal processing system of claim 19, wherein the said waveguides can be aligned, assembled and fixed onto substrates and carrier substrates with micromachined V-shaped and U-shaped grooves; wherein the said waveguides and apparatus can be aligned, assembled, fixed and packaged with the aids of V-shaped and U-shaped grooves, microstructures of mesa, and self-alignment process contributed by the surface tension of the solder materials.

25. The apparatus for optical signal processing system of claim 19, wherein the said micro-mirrors can be driven based on known actuation schemes including thermal, thermoelectrical, electro-thermal, electro-static, electromagnetic, magnetic, piezoelectric, air pressure difference, and hydraulic pressure difference.

26. The apparatus for optical signal processing system of claim 19, wherein the said one-dimensional array of micro-mirrors can be optionally replaced by reflective mirrors with fixed facet angle manufactured by micromachining, microfabrication, or electroplating technologies; wherein the said one-dimensional array of micro-mirrors can be optionally replaced by optical fibers and optical planar waveguides with 45° facet end; such that the transmitting directions of said optical signals will be changed in a fixed deflection angles.

27. The apparatus for optical signal processing system of claim 19, where optical devices and elements can enhance the optical transmission efficiency or optical coupling efficiency at the interface of input and output among every discrete functional optical, optoelectrical, optomechanical, and micro-electro-mechanical elements; wherein the said optical devices and elements can be each type of collimating lens; wherein the said optical devices and elements can be collecting lens such as ball lens, cylindrical lens, and refractive micro-lens; wherein the said optical-devices and elements can be diffractive micro-lens such as Fresnel lens, and non-spherical lens.

28. The apparatus for optical signal processing system of claim 19, wherein the said apparatus can be prepared in separated substrates, during the manufacturing process the electrical, optoelectrical, optical, microelectromechanical types of active devices and passive devices can be selectively die bonded, flip-chip bonded, or die attached on to aforementioned substrates, then these substrates are fixed or bonded together by the known micromachining and packaging technologies. The above-mentioned apparatus and devices and elements can be aligned, assembled and packaged with the aids of V-shaped and U-shaped grooves, microstructures of mesa, self-alignment process contributed by the surface tension of the solder materials.

29. The apparatus for optical signal processing system of claim 19, wherein the said apparatus can be prepared in separated substrates, wherein materials of the said substrates can be semiconductors, glass, metals, or polymers.

30. The apparatus for optical signal processing system of claim 19, wherein the said apparatus can be prepared in separated wafers, during the manufacturing process the electrical, optoelectrical, optical, microelectromechanical types of active devices and passive devices can be selectively die bonded, flip-chip bonded, or die attached on to aforementioned wafers, then the said apparatus can be made by bonding separated wafers together; where all the functional elements are hybrid assembled or integrated onto these wafers via using the known micromachining, microfabrication, wafer level packaging, flip-chip bonding, multi-chip module technologies; then the bonded wafers of numerous apparatus can be diced or separated into discrete devices or apparatus; finally the aligning and sealing process of the optical fibers or arrayed waveguides are proceeded. The above-mentioned apparatus and devices and elements can be aligned, assembled and packaged with the aids of V-shaped and U-shaped grooves, microstructures of mesa, self-alignment process contributed by the surface tension of the solder materials; wherein materials of the said wafers can be semiconductors, glass, or polymer.

31. An apparatus for optical signal processing system, comprising:
At least an optical input terminal of an one-dimensional array of waveguides;
At least an optical output terminal of an one-dimensional array of waveguides;
A plurality of one-dimensional arrays of micro-mirrors manufactured by using the micro-electro-mechanical technology for switching and re-directing the transmitting directions of each individual optical signal with specific wavelength for each channels between the said optical input terminals and said optical output terminals;
wherein a part of channels of the said waveguides of a single input terminal or of plural input terminals can be input ports for handling the existing optical signals of on-going traffic, while the rest part of channels of the said waveguides of a single input terminal or of plural input terminals can be adding ports for originating new optical signals with specific wavelengths into current traffic;
wherein a part of channels of the said waveguides of a single output terminal or of plural output terminals can be output ports for handling the existing optical signals of on-going traffic, while the rest part of channels of the said waveguides of a single output terminal or of plural output terminals can be dropping ports for terminating optical signals with specific wavelengths from current traffic;
wherein a set of demultiplexed or separated WDM (wavelength division multiplexing) optical signals with multiple wavelengths can be transmitted through a part of channels of the said an one-dimensional array of waveguides of input terminals;
wherein the said plural one-dimensional arrays of micro-mirrors are used for changing and re-directing the transmitting directions of the said optical signal among the corresponding reflective mirrors of different arrays. Thus optical signals of specified wavelengths belonging to respective channels can be switched from input channels or adding channels to output channels or dropping channels.
wherein a set of output optical signals with multiple wavelengths after the optional operation of transmitting direction adjustment of these optical signals by using micro-mirrors can be converged and multiplexed into a part of channels of the said an one-dimensional array of waveguides of output terminals; By using this method, the optical signal with specified wavelength can be added or dropped independently for each corresponding channels. In this way, the claimed apparatus is a wavelength selective optical add/drop multiplexer (WSOADM), or a refigurable optical add/drop multiplexer (ROADM).

32. The apparatus for optical signal processing system of claim 31, wherein the said waveguides can be the optical planar waveguide elements and optical fibers;

33. The apparatus for optical signal processing system of claim 31, wherein the said waveguides can partially be the optical planar waveguide elements, while the rest part of waveguides is an array of optical fibers.

34. The apparatus for optical signal processing system of claim 31, wherein the said waveguides can be aligned, assembled and fixed onto substrates and carrier substrates with micromachined V-shaped and U-shaped grooves; wherein the said waveguides and apparatus can be aligned, assembled, fixed and packaged with the aids of V-shaped and U-shaped grooves, microstructures of mesa, and self-alignment process contributed by the surface tension of the solder materials.

35. The apparatus for optical signal processing system of claim 31, wherein the said micro-mirrors can be driven based on known actuation schemes including thermal, thermoelectrical, electro-thermal, electro-static, electromagnetic, magnetic, piezoelectric, air pressure difference, and hydraulic pressure difference.

36. The apparatus for optical signal processing system of claim 18, wherein the said one-dimensional array of micro-mirrors can be optionally replaced by reflective mirrors with fixed facet angle manufactured by micrmachining, microfabrication, or electroplating technologies; wherein the said one-dimensional array of micro-mirrors can be optionally replaced by optical fibers and optical planar waveguides with 45° facet end; such that the transmitting directions of said optical signals will be changed in a fixed deflection angles.

37. The apparatus for optical signal processing system of claim 31, wherein said optical input terminal of an one-dimensional array of waveguides can be the 1×N arrayed waveguide grating which acts as an optical signal demultiplexer, such that the input optical signals with multiple wavelengths from a single channel of the input terminal are separated and demultiplexed, according to its wavelength difference, and then transmitted to each corresponding optical channels.

38. The apparatus for optical signal processing system of claim 31, wherein the said adding and dropping channels or ports are adder and dropper of OADM devices in optical networks of the said optical communication systems; whereas new signals can be add into signal traffic through the adder, and signals can be terminated from current signal traffic via dropper.

39. The apparatus for optical signal processing system of claim 31, wherein one of the said optical input terminal of an one-dimensional array of waveguides can be used as the adding ports of new optical signals with specific wavelengths into current traffic, after the optional operation of transmitting direction adjustment of these optical signals by using micro-mirrors, then these add-in new signals can be individually transmitted into corresponding output channels depending on their relative wavelengths. Therefore the optical signals can be added into traffic independently for each channel.

40. The apparatus for optical signal processing system of claim 31, wherein one of the said optical output terminal of an one-dimensional array of waveguides can be used as the termination ports of optical signals existing in present traffic which are need to be dropped out, where these optical signals may need the operation of transmitting direction adjustment by using micro-mirrors to help themselves switch from the corresponding output terminal to drop terminal. Thus the optical signals of different channels can be independently dropped.

41. The apparatus for optical signal processing system of claim 31, wherein one of the said optical output terminal of an one-dimensional array of waveguides can be the N×1 arrayed waveguide grating which acts as an optical signal multiplexer, such that the output optical signals with multiple wavelengths after the optional operation of transmitting direction adjustment of these optical signals by using micro-mirrors can be converged and multiplexed to form a multi-wavelength optical signal in single output terminal.

42. The apparatus for optical signal processing system of claim 31, wherein the said one-dimensional array of waveguides of input terminals can be further connected with a demultiplexer using a 1×N arrayed waveguide grating, fiber grating, or thin film filter. Thus the input optical signals with multiple wavelengths from a single input terminal will be separated and demultiplexed into several signals, and these demultiplexed signals will transmit in the said one-dimensional array of waveguides with a way that each channel has optical signals of one specific wavelength.

43. The apparatus for optical signal processing system of claim 31, wherein the said one-dimensional array of waveguides of output terminals can be further connected with a multiplexer using a N×1 arrayed waveguide grating, fiber gratings, or thin film filters. Thus the output optical signals with various wavelengths from each channels of the said one-dimensional array of waveguides will be converged and multiplexed into a set of optical signals with multiple optical wavelengths, and thereafter these multiplexed signals will transmit in a single output terminal.

44. The apparatus for optical signal processing system of claim 31, wherein demultiplexing/seperating element is used to separate or demultiplex optical signals from a single channel into the said a set of demultiplexed or separated WDM optical signals with multiple wavelengths, and this demultiplexing/seperating element is the demultiplexer of wavelength division multiplexing (WDM) devices in optical networks of the said optical communication systems; whereas a set of optical signals with multiple wavelengths can be processed independently corresponding to each channels.

45. The apparatus for optical signal processing system of claim 31, wherein multiplexing/converging element is used to converge or multiplex the said a set of optical signals with multiple wavelengths into a single channel, and this multiplexing/converging element is the multiplexer of wavelength division multiplexing (WDM) devices in optical networks of the said optical communication systems; whereas a set of optical signals with multiple wavelengths can be processed independently corresponding to each channels.

46. The apparatus for optical signal processing system of claim 31, where optical devices and elements can enhance the optical transmission efficiency or optical coupling efficiency at the interface of input and output among every discrete functional optical, optoelectrical, optomechanical, and micro-electro-mechanical elements; wherein the said optical devices and elements can be each type of collimating lens; wherein the said optical devices and elements can be collecting lens such as ball lens, cylindrical lens, and refractive micro-lens; wherein the said optical devices and elements can be diffractive micro-lens such as Fresnel lens, and non-spherical lens.

47. The apparatus for optical signal processing system of claim 30, wherein the said apparatus can be prepared in separated substrates, during the manufacturing process the electrical, optoelectrical, optical, microelectromechanical types of active devices and passive devices can be selectively die bonded, flip-chip bonded, or die attached on to aforementioned substrates, then these substrates are fixed or bonded together by the known micromachining and packaging technologies. The above-mentioned apparatus and devices and elements can be aligned, assembled and packaged with the aids of V-shaped and U-shaped grooves, microstructures of mesa, self-alignment process contributed by the surface tension of the solder materials.

48. The apparatus for optical signal processing system of claim 30, wherein the said apparatus can be prepared in separated substrates, wherein materials of the said substrates can be semiconductors, glass, metals, or polymers.

49. The apparatus for optical signal processing system of claim 30, wherein the said apparatus can be prepared in separated wafers, during the manufacturing process the electrical, optoelectrical, optical, microelectromechanical types of active devices and passive devices can be selectively die bonded, flip-chip bonded, or die attached on to aforementioned wafers, then the said apparatus can be made by bonding separated wafers together; where all the functional elements are hybrid assembled or integrated onto these wafers via using the known micromachining, microfabrication, wafer level packaging, flip-chip bonding, multi-chip module technologies; then the bonded wafers of numerous apparatus can be diced or separated into discrete devices or apparatus; finally the aligning and sealing process of the optical fibers or arrayed waveguides are proceeded. The above-mentioned apparatus and devices and elements can be aligned, assembled and packaged with the aids of V-shaped and U-shaped grooves, microstructures of mesa, self-alignment process contributed by the surface tension of the solder materials; wherein materials of the said wafers can be semiconductors, glass, or polymer.
